(19) United States
(12) Patent Application Publication
(10) Pub. No.: US 2018/0004564 A1
(43) Pub. Date: Jan. 4, 2018

(54) NON-TRANSITORY COMPUTER-READABLE STORAGE MEDIUM, LIVE MIGRATION METHOD, AND LIVE MIGRATION APPARATUS

(71) Applicant: FUJITSU LIMITED, Kawasaki-shi (JP)

(72) Inventor: Yotaro KONISHI, Yokohama (JP)

(73) Assignee: FUJITSU LIMITED, Kawasaki-shi (JP)

(21) Appl. No.: 15/632,930

(22) Filed: Jun. 26, 2017

(30) Foreign Application Priority Data
Jul. 1, 2016 (JP) 2016-132018

(51) Int. Cl. G06F 9/455; G06F 3/06; G06F 9/48; G06F 9/50

(52) U.S. Cl. CPC G06F 9/45558; G06F 9/5088; G06F 9/5016; G06F 3/0647; G06F 3/065; G06F 9/4856

(57) ABSTRACT

A non-transitory computer-readable storage medium that stores a live migration program that causes a computer to execute a process, the process including starting live migration of a virtual machine to another computer in response to reception of an instruction of the live migration of the virtual machine, an emulator which becomes a substitute for hardware capable of dynamically defining a function is implemented in the virtual machine, causing the emulator to execute a requested process requested from the virtual machine to the hardware when a degree of progress taken to transmit data of the live migration of the virtual machine satisfies a first condition, and switching the computer executing the virtual machine to the other computer when the degree of progress satisfies a second condition to determine whether the computer executing the virtual machine is switched and when the hardware is not executing a process of the virtual machine.

### CROSS-REFERENCE TO RELATED APPLICATION

This application is based upon and claims the benefit of priority of the prior Japanese Patent Application No. 2016-132018, filed on Jul. 1, 2016, the entire contents of which are incorporated herein by reference.

### FIELD

The embodiment discussed herein is related to a non-transitory computer-readable storage medium, a live migration method, and a live migration apparatus.

### BACKGROUND

In the related art, there are field-programmable gate arrays (FPGAs) capable of defining or updating functions after manufacturing. Further, there are live migration technologies for moving virtual machines between servers while suppressing times at which the virtual machines stop.

As the associated technologies, for example, there are technologies for exchanging hardware supporting memory positions associated with virtual machines with support mechanisms. For example, there is a technology for selecting optimum physical hardware which affords to execute a process for a traffic generation amount and executing live migration of a virtual machine to the selected physical hardware in a case in which the traffic generation amount expected to occur in the future exceeds an optimum value. For example, there is a technology for migrating a single virtual machine or a plurality of virtual machines between a plurality of hardware resources when a calculated resource consumption amount of hardware resources after the migration is less than a current measured resource consumption amount.

Japanese National Publication of International Patent Application No. 2012-504296, International Publication Pamphlet No. WO 2013038585, and Japanese Laid-open Patent Publication No. 2014-206805 are examples of the related art.

### SUMMARY

According to an aspect of the invention, a non-transitory computer-readable storage medium that stores a live migration program that causes a computer to execute a process, the process including starting live migration of a virtual machine to another computer in response to reception of an instruction of the live migration of the virtual machine, an emulator which becomes a substitute for hardware capable of dynamically defining a function is implemented in the virtual machine, causing the emulator to execute a requested process requested from the virtual machine to the hardware when a degree of progress taken to transmit data of the live migration of the virtual machine satisfies a first condition, and switching the computer executing the virtual machine to the other computer when the degree of progress satisfies a second condition to determine whether the computer executing the virtual machine is switched and when the hardware is not executing a process of the virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a live migration method according to an embodiment;

FIG. 2 is an explanatory diagram illustrating an example of a live migration system;

FIG. 3 is a block diagram illustrating a hardware configuration example of an information processing apparatus;

FIG. 4 is an explanatory diagram illustrating an example of memory content of an accelerator table according to Example 1;

FIG. 5 is an explanatory diagram illustrating an example of memory content of a storage destination path table according to Example 1;

FIG. 6 is an explanatory diagram illustrating an example of memory content of an FPGA execution status table according to Example 1;

FIG. 7 is an explanatory diagram illustrating an example of memory content of an FPGA execution mode table according to Example 1;

FIG. 8 is a block diagram illustrating a functional configuration example of the information processing apparatus according to Example 1;

FIG. 9 is an explanatory diagram illustrating a module configuration example of the information processing apparatus according to Example 1;

FIG. 10 is an explanatory diagram (part 1) illustrating an example of the flow of an operation of the information processing apparatus according to Example 1;

FIG. 11 is an explanatory diagram (part 2) illustrating the example of the flow of an operation of the information processing apparatus according to Example 1;

FIG. 12 is an explanatory diagram (part 3) illustrating the example of the flow of an operation of the information processing apparatus according to Example 1;

FIG. 13 is an explanatory diagram (part 4) illustrating the example of the flow of an operation of the information processing apparatus according to Example 1;

FIG. 14 is an explanatory diagram illustrating an example of the flow of live migration according to Example 1;

FIG. 15 is a flowchart illustrating an example of a VM activation process procedure according to Example 1;

FIG. 16 is a flowchart illustrating an example of a hardware access process procedure according to Example 1;

FIG. 17 is a flowchart illustrating an example of an FPGA access process procedure according to Example 1;

FIG. 18 is a flowchart illustrating an example of an LM execution process procedure according to Example 1;

FIG. 19 is an explanatory diagram illustrating an example of memory content of an FPGA execution mode table according to Example 2;

FIG. 20 is an explanatory diagram illustrating an example of memory content of a mode switch timing table according to Example 2;

FIG. 21 is an explanatory diagram illustrating a module configuration example of an information processing apparatus according to Example 2;

FIG. 22 is a flowchart illustrating an example of a VM activation process procedure according to Example 2;

FIG. 23 is a flowchart illustrating an example of an FPGA access process procedure according to Example 2;

FIG. 24 is a flowchart illustrating an example of an LM execution process procedure according to Example 2;

FIG. 25 is an explanatory diagram illustrating a module configuration example of an information processing apparatus according to Example 3; and

FIG. 26 is a flowchart illustrating an example of an FPGA access process procedure according to Example 3.

### DESCRIPTION OF EMBODIMENT

In the above-described related art, however, when live migration is executed while a virtual machine uses FPGA, data of FPGA is not included in a state of the virtual machine transmitted to a movement destination. Therefore, a trouble in which a virtual machine may not acquire data from FPGA at the movement destination occurs in some cases.

According to an aspect, an object of an embodiment is to provide a live migration program and a live migration method capable of suppressing occurrence of a trouble of a virtual machine at a movement destination of live migration.

Hereinafter, embodiments of a live migration program and a live migration method will be described in detail with reference to the drawings.

Example of Live Migration Method According to Embodiment

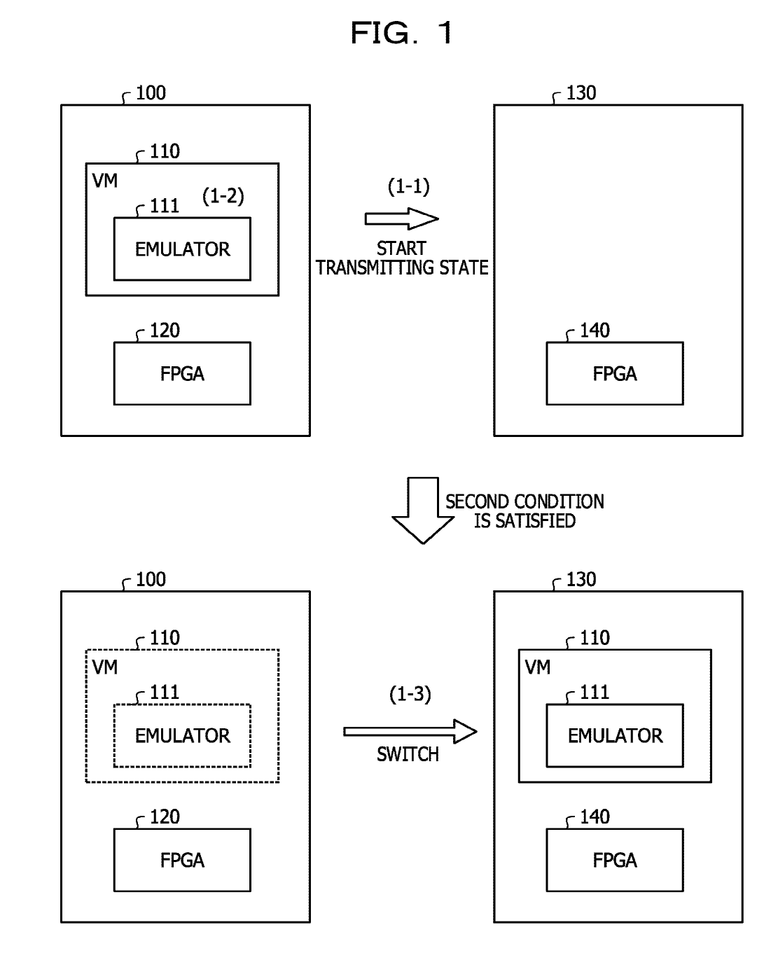

FIG. 1 is an explanatory diagram illustrating an example of a live migration method according to an embodiment. In FIG. 1, an information processing apparatus 100 is a computer that has hardware capable of dynamically defining a function and executes a virtual machine. A virtual environment of the information processing apparatus 100 may be a hypervisor type virtual environment or may be a host type virtual environment.

The hardware capable of dynamically defining a function is, for example, an FPGA. The FPGA can realize hardware specialized for a specific process and can execute the specific process more efficiently than a central processing unit (CPU). The FPGA realizes, for example, an accelerator. In the following description, the virtual machine is denoted by a “VM” in some cases.

Here, a case in which a process for the VM becomes efficient when the VM uses the FPGA is considered. For example, the VM includes a virtual FPGA in some cases. When the virtual FPGA receives a request for a process using an accelerator from the VM, the virtual FPGA causes the FPGA included in the information processing apparatus 100 to execute a process using the accelerator by transmitting the received request to the FPGA included in the information processing apparatus 100.

There is a technology for live migration in which a VM is moved between servers while suppressing a time in which the VM is stopped. For example, a movement source server transmits a state of the VM to a movement destination server. When the movement source server ends the transmission of the state of the VM, the VM is stopped and the movement destination server of the VM resumes the VM. The state is a status of a memory or a register included in the movement source server.

However, in a case in which the VM uses the FPGA, there is a possibility of a trouble occurring in the VM in the movement destination server when the technology for the live migration is applied. For example, in the technology for the live migration, it is difficult to transmit the state of the FPGA for which the movement source server is independently operating from a CPU even when the movement source server can transmit the state of the VM to the movement destination server.

As a result, in the movement destination server, the VM does not acquire a process result of the FPGA. As a result, a trouble consequently occurs in some cases. Specifically, in the movement destination server, the VM continues to wait for the process result of the FPGA, and thus an error occurs in some cases. In addition, the FPGA does not exist in the movement destination server in some cases. In the cases, the VM outputs a request for a process using an accelerator to the FPGA which does not exist, and thus an error occurs in some cases.

Accordingly, in the embodiment, a live migration method of suppressing occurrence of a trouble of a VM in a movement destination computer by embedding an emulator of an FPGA in the VM and causing the VM to appropriately use the FPGA and the emulator of the FPGA will be described.

In an example of FIG. 1, the information processing apparatus 100 includes an FPGA 120 as hardware capable of dynamically defining a function and executes a VM 110. In the VM 110, an emulator 111 which becomes a substitute for the hardware capable of dynamically defining a function is embedded. In the VM 110, for example, the emulator 111 which becomes a substitute for the FPGA 120 is embedded.

The emulator 111 is software that becomes a substitute for hardware capable of dynamically defining a function and emulating an operation of the hardware capable of dynamically defining a function. The emulator 111 is, for example, a substitute for the FPGA 120, emulates at least a part of an operation of the FPGA 120, and executes the same operation as a part of an operation of the FPGA 120. The emulator 111 may emulate, for example, an error operation of the FPGA 120. Specifically, the emulator 111 outputs the same error response as an error response output when the FPGA 120 fails to execute a process.

In the example of FIG. 1, the information processing apparatus 100 is connected to be able to communicate with a movement destination apparatus 130. The movement destination apparatus 130 is a computer that includes an FPGA 140 which is the same as the FPGA 120 included in the information processing apparatus 100 and is a movement destination computer of the VM 110 through live migration.

(1-1) The information processing apparatus 100 starts the live migration of the VM 110 to another computer in reception of an instruction of the live migration of the VM 110. The other computer is, for example, the movement destination apparatus 130. The information processing apparatus 100 starts copying a state of the VM 110 to the movement destination apparatus 130, for example, by transmitting the state of the VM 110 to the movement destination apparatus 130.

(1-2) The information processing apparatus 100 determines whether the degree of progress taken to transmit data of the live migration of the VM 110 satisfies a first condition. For example, the degree of progress is expressed by, for example, a ratio of the state transmitted to the movement destination apparatus 130 to the state of the VM 110. The degree of progress may be expressed by, for example, a time remaining until completion of transmission of the state of the VM 110. The first condition is a condition that there is an opportunity to switch from a status in which the FPGA 120 is caused to execute a process to a status in which the emulator 111 of the FPGA 120 is caused to execute the process. The first condition is, for example, a condition that the live migration of the VM 110 is being executed. The first condition may be, for example, a condition that a ratio of the state transmitted to the movement destination apparatus 130 to the state of the VM 110 is equal to or greater than the first threshold. Then, when the first condition is satisfied, the information processing apparatus 100 causes the emulator 111 to execute the process requested from the VM 110 to the FPGA 120 instead of the FPGA 120.

Thus, the information processing apparatus 100 can cause the FPGA 120 not to be used earlier than switching of the computer executing the VM 110 so that the FPGA 120 is not used at the time of switching the computer executing the VM 110. Before the degree of progress taken to transmit data of the live migration of the VM 110 satisfies the first condition, the information processing apparatus 100 can cause the FPGA 120 to execute the process requested from the VM 110 to the FPGA 120, and thus it is possible to suppress deterioration in performance of the VM 110.

(1-3) The information processing apparatus 100 determines whether the degree of progress taken to transmit data of the live migration of the VM 110 satisfies a second condition. The second condition is a condition that there is an opportunity to complete the transmission of the state of the VM 110. The second condition is also, for example, a condition that the VM 110 is stopped and the computer executing the VM 110 is switched. The second condition may be, for example, a condition that the ratio of the state transmitted to the movement destination apparatus 130 to the state of the VM 110 is equal to or greater than a second threshold.

When the second condition is satisfied and the FPGA 120 is not executing the process on the VM 110, the information processing apparatus 100 switches the computer executing the VM 110 to another computer. For example, when the second condition is satisfied and the FPGA 120 is not executing the process on the VM 110, the information processing apparatus 100 stops the VM 110, completes the transmission of the state of the VM 110, and switches the computer executing the VM 110 to the movement destination apparatus 130.

Thus, the information processing apparatus 100 can switch the computer executing the VM 110 when the FPGA 120 is not being used. Thus, in the movement destination apparatus 130, the VM 110 may not acquire a process result of the FPGA 120. Thus, the information processing apparatus 100 can suppress occurrence of a trouble in which the VM 110 does not acquire a process result in the movement destination apparatus 130 from the FPGA 120, and thus it is possible to suppress occurrence of the trouble of the VM 110 in the movement destination apparatus 130.

Example of Live Migration System 200

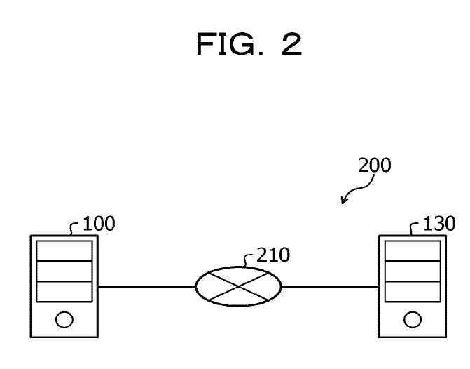

Next, an example of a live migration system 200 to which the information processing apparatus 100 illustrated in FIG. 1 is applied will be described with reference to FIG. 2.

FIG. 2 is an explanatory diagram illustrating an example of the live migration system 200. In FIG. 2, the live migration system 200 includes the information processing apparatus 100 and the movement destination apparatus 130. In the live migration system 200, the information processing apparatus 100 and the movement destination apparatus 130 are connected to each other via a wired or wireless network 210. The network 210 is, for example, a local area network (LAN), a wide area network (WAN), or the Internet.

The information processing apparatus 100 is, for example, a server, a personal computer (PC), and a notebook type PC. The movement destination apparatus 130 is a computer that includes the FPGA 120 and a movement destination of the VM 110 through the live migration. The movement destination apparatus 130 is, for example, a server, a PC, or a notebook type PC. The movement destination apparatus 130 may also have the function of the information processing apparatus 100.

Hardware Configuration Example of Information Processing Apparatus 100

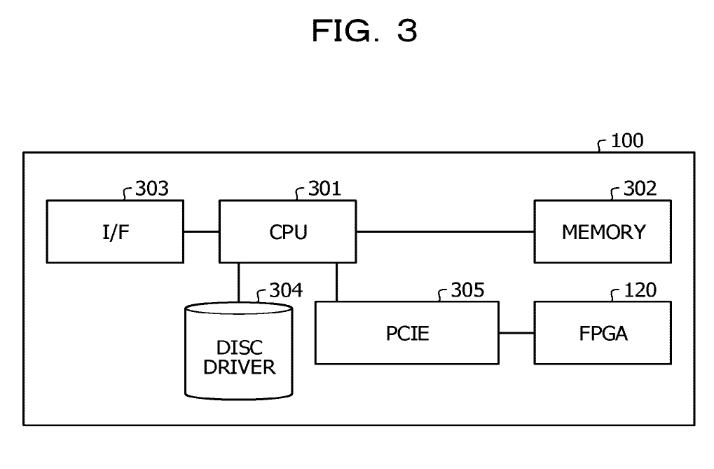

Next, a hardware configuration example of the information processing apparatus 100 will be described with reference to FIG. 3.

FIG. 3 is a block diagram illustrating a hardware configuration example of an information processing apparatus 100. In FIG. 3, the information processing apparatus 100 includes a CPU 301, a memory 302, an interface (I/F) 303, a disc driver 304, a peripheral component interconnect express (PCIE) 305, and the FPGA 120. The constituent elements are connected to each other via buses.

Here, the CPU 301 governs control of the entire information processing apparatus 100. The memory 302 includes, for example, a read-only memory (ROM), a random access memory (RAM), and a flash ROM. Specifically, for example, the flash ROM or the ROM stores various programs and the RAM is used as a work area of the CPU 301. The various programs include, for example, a live migration program according to the embodiment. The programs stored in the memory 302 are loaded to the CPU 301 and cause the CPU 301 to execute coding processes.

The I/F 303 is connected to the network 210 via a communication line and is connected to another computer (for example, the movement destination apparatus 130 illustrated in FIG. 2) via the network 210. Then, the I/F 303 governs the network 210 and an internal interface to control input and output of data to and from the other computer. For example, a modem or a LAN adapter can be adopted in the I/F 303.

The disc driver 304 includes a disc and controls reading and writing of data from and on the disk under the control of the CPU 301. The disc driver 304 is, for example, a magnetic disc driver. The disc is a non-volatile memory that stores data written under the control of the disc driver 304. The disc is, for example, a magnetic disk or an optical disc. The PCIE 305 and the FPGA 120 are connected to each other and govern the FPGA 120 and the internal interface to control input and output of data to and from the FPGA 120. The FPGA 120 is hardware capable of dynamically defining a function.

The information processing apparatus 100 may include, for example, a solid state drive (SSD), a keyboard, a mouse, and a display in addition to the above-described constituent elements. The information processing apparatus 100 may include an SSD or the like instead of the disc driver 304. The hardware configuration example of the movement destination apparatus 130 is the same as the hardware configuration example of the information processing apparatus 100 illustrated in FIG. 3, and thus the description thereof will be omitted.

Example 1 in Live Migration System 200

Next, Examples 1 to 3 in the live migration system 200 illustrated in FIG. 2 will be described. Example 1 is an example in which execution of a process by the FPGA 120 and execution of the process by the emulator 111 of the FPGA 120 are switched according to the degree of progress taken to transmit data of live migration of the VM 110.

Example 2 is an example in which execution of a process by the FPGA 120 and execution of the process by the emulator 111 of the FPGA 120 are switched at a timing different for each kind of accelerator used for the process requested from the VM 110 to the FPGA 120.

Example 3 is the same example as Example 2 and is an example in which a timing at which whether the FPGA 120 is caused to execute a process in Example 2 or the emulator 111 of the FPGA 120 is caused to execute a process is switched is dynamically changed. In the following description, Example 1 will be first described.

Memory Content of Accelerator Table 400 in Example 1

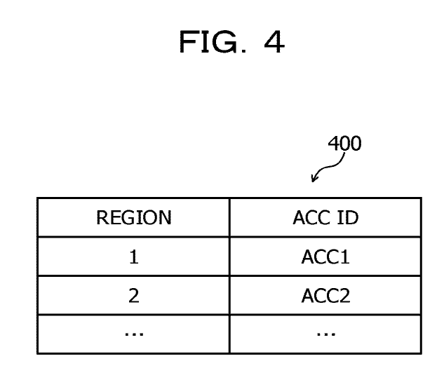

First, an example of memory content of an accelerator table 400 stored by the information processing apparatus 100 in Example 1 will be described with reference to FIG. 4. The accelerator table 400 is realized by, for example, a memory region of the memory 302, the disc driver 304, or the like of the information processing apparatus 100 illustrated in FIG. 3.

FIG. 4 is an explanatory diagram illustrating an example of memory content of the accelerator table 400 according to Example 1. As illustrated in FIG. 4, the accelerator table 400 has fields of a region and an ACC ID. In the accelerator table 400, accelerator mounting information is stored as a record by setting information in each field for each accelerator.

In the field of the region, a record number is set. In the field of the ACC ID, identification information for uniquely specifying an accelerator is set. In this way, the accelerator table 400 enables a certain type of accelerator realized by the FPGA 120 to be managed. The accelerator table 400 enables the preferable emulator 111 corresponding to a certain type of accelerator and embedded in the VM 110 to be determined.

Memory Content of Storage Destination Path Table 500 in Example 1

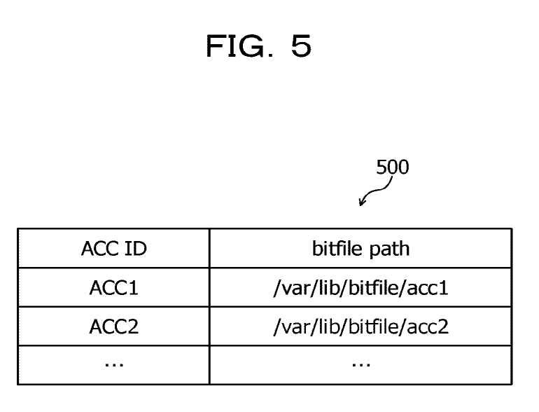

Next, an example of memory content of a storage destination path table 500 stored by the information processing apparatus 100 in Example 1 will be described with reference to FIG. 5. The storage destination path table 500 is realized by, for example, a memory region of the memory 302, the disc driver 304, or the like of the information processing apparatus 100 illustrated in FIG. 3.

FIG. 5 is an explanatory diagram illustrating an example of memory content of a storage destination path table 500 according to Example 1. As illustrated in FIG. 5, the storage destination path table 500 has fields of an ACC ID and a bitfile path. In the storage destination path table 500, storage destination path information is stored as a record by setting information in each field for each accelerator.

In the field of the ACC ID, identification information for uniquely specifying an accelerator is set. In the field of the bitfile path, a path to a memory region in which an emulator code for realizing an accelerator is stored is set. In this way, the storage destination path table 500 enables a location where the emulator code of a certain type of accelerator is stored in the memory region to be specified.

Memory Content of FPGA Execution Status Table 600 in Example 1

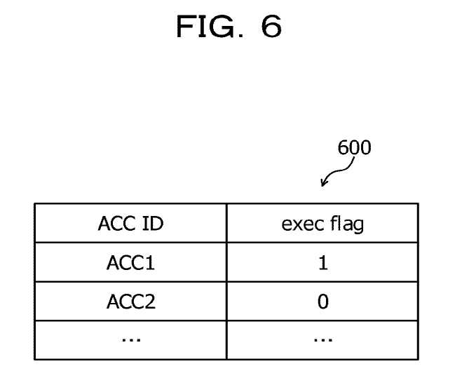

Next, an example of memory content of an FPGA execution status table 600 stored by the information processing apparatus 100 in Example 1 will be described with reference to FIG. 6. The FPGA execution status table 600 is realized by, for example, a memory region of the memory 302, the disc driver 304, or the like of the information processing apparatus 100 illustrated in FIG. 3.

FIG. 6 is an explanatory diagram illustrating an example of memory content of the FPGA execution status table 600 according to Example 1. As illustrated in FIG. 6, the FPGA execution status table 600 has fields of an ACC ID and an exec flag. In the FPGA execution status table 600, execution status information is stored as a record by setting information in each field for each accelerator.

In the field of the ACC ID, identification information for uniquely specifying an accelerator is set. In the field of the exec flag, an exec flag indicating whether an accelerator realized by the FPGA 120 is executing a process on the VM 110 is set. For example, the exec flag is “1” when the process is being executed, and is 0 when the process is not being executed. In this way, the FPGA execution status table 600 enables whether the FPGA 120 is executing the process on the VM 110 to be determined when the computer executing the VM 110 is switched.

Memory Content of FPGA Execution Mode Table 700 in Example 1

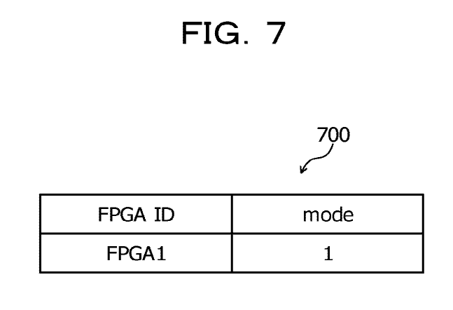

Next, an example of memory content of an FPGA execution mode table 700 stored by the information processing apparatus 100 in Example 1 will be described with reference to FIG. 7. The FPGA execution mode table 700 is realized by, for example, a memory region of the memory 302, the disc driver 304, or the like of the information processing apparatus 100 illustrated in FIG. 3.

FIG. 7 is an explanatory diagram illustrating an example of memory content of the FPGA execution mode table 700 according to Example 1. As illustrated in FIG. 7, the FPGA execution mode table 700 has fields of an FPGA ID and a mode. In the FPGA execution mode table 700, execution mode information is stored as a record by setting information in each field for the FPGA 120.

In the field of the FPGA ID, identification information for uniquely specifying the FPGA 120 is set. In the field of the mode, a mode indicating whether an accelerator realized by the FPGA 120 is caused to execute the process on the VM 110 or the emulator 111 corresponding to an accelerator realized by the FPGA 120 is caused to execute the process is set. For example, the mode is “1” in a case in which the accelerator is caused to execute the process, and is “0” in a case in which the emulator 111 is caused to execute the process. In this way, the FPGA execution mode table 700 enables whether the accelerator is caused to execute the process on the VM 110 or the emulator 111 is caused to execute the process to be determined.

Here, the case in which the execution mode information is stored as a record in the FPGA execution mode table 700 by setting the information in each field in the FPGA 120 has been described, but the embodiment is not limited thereto. For example, in the FPGA execution mode table 700, the execution mode information of each accelerator may be stored as a record by setting the information in each field for each accelerator realized by the FPGA 120.

Thus, the FPGA execution mode table 700 enables whether the accelerator is caused to execute the process on the VM 110 using the accelerator or the emulator 111 is caused to execute the process to be determined for each accelerator. A case in which information is set in each field for each accelerator realized by the FPGA 120 in the FPGA execution mode table 700 will be described in Example 2.

Functional Configuration Example of Information Processing Apparatus 100 in Example 1

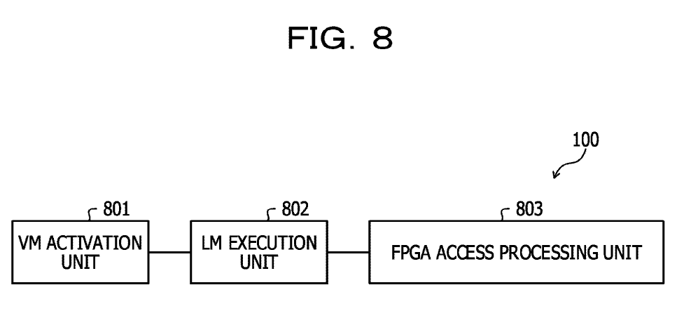

Next, a functional configuration example of the information processing apparatus 100 in Example 1 will be described with reference to FIG. 8.

FIG. 8 is a block diagram illustrating a functional configuration example of the information processing apparatus 100 according to Example 1. As illustrated in FIG. 8, the information processing apparatus 100 is configured to include a VM activation unit 801, a live migration execution unit 802, and an FPGA access processing unit 803. In the following description, the live migration execution unit 802 is notated as a “live migration (LM) execution unit 802” in some cases.

The VM activation unit 801 to the FPGA access processing unit 803 are functions of a control unit. Specifically, the functions of the VM activation unit 801 to the FPGA access processing unit 803 are realized, for example, by causing the CPU 301 or the I/F 303 to execute programs stored in a memory region of the memory 302, the disc driver 304, or the like illustrated in FIG. 3. A process result of each functional unit is stored in, for example, a memory region of the memory 302, the disc driver 304, or the like.

The VM activation unit 801 embeds the emulator 111 which becomes a substitute of hardware capable of dynamically defining a function at the time of activating the VM 110 in the VM 110. The hardware capable of dynamically defining a function is a programmable logic device (PLD). The PLD is, for example, the FPGA 120. The FPGA 120 can realize hardware specialized for a specific process and can execute the specific process more efficiently than a CPU. For example, the FPGA 120 realizes an accelerator so that an operation of the VM 110 can be efficient.

The emulator 111 is software that becomes a substitute for hardware capable of dynamically defining a function and emulates an operation of the hardware capable of dynamically defining a function. For example, the emulator 111 becomes a substitute of the FPGA 120, emulates at least a part of the operation of the FPGA 120, and executes the same operation of the part of the operation of the FPGA 120. Specifically, the emulator 111 emulates an operation of any of one or more accelerators realized by the FPGA 120 and execute the same operation of as the operation of any accelerator. Here, the number of emulators 111 may be plural. For example, there may be the emulator 111 corresponding to each accelerator realized by the FPGA 120.

For example, the emulator 111 may emulate a dummy operation of the FPGA 120. Specifically, the emulator 111 outputs dummy data corresponding to any of one or more accelerators in realized by the FPGA 120. At this time, the emulator 111 may wait for a predetermined time until the dummy data is output. The dummy data is data which is determined not to cause a problem in another process even the dummy data is output from the accelerator by a generator or the like of the accelerator and is used for the other process. The dummy data may be data which is set so that the VM determines that an error occurs in a process when the dummy data is output from the accelerator by the generator or the like of the accelerator.

For example, the emulator 111 may emulate an error operation of the FPGA 120. Specifically, the emulator 111 outputs the same error response to an error response output when any of one or more accelerators realized by the FPGA 120 fails to execute a process. At this time, the emulator 111 may wait for a predetermined time until the error response is output. The emulator 111 may wait without executing a process and cause the VM to execute the process again after a predetermined time.

For example, referring to the accelerator table 400 illustrated in FIG. 4, the VM activation unit 801 specifies a type of accelerator realized by the FPGA 120. For example, referring to the storage destination path table 500 illustrated in FIG. 5, the VM activation unit 801 embeds the emulator 111 corresponding to the specified type of accelerator in the VM 110.

Specifically, referring to the accelerator table 400 illustrated in FIG. 4, the VM activation unit 801 reads ACC IDs “ACC1 and ACC 2” for uniquely specifying the accelerator realized by the FPGA 120. Next, referring to the storage destination path table 500 illustrated in FIG. 5, the VM activation unit 801 reads bitfile path “/var/lib/bitfile/acc1 and/var/lib/bitfile/acc2” corresponding to the ACC IDs “ACC1 and ACC2”.

Then, the VM activation unit 801 reads an emulator code of the accelerator from the memory region indicated by bitfile paths “/var/lib/bitfile/acc1 and/var/lib/bitfile/acc2”. The VM activation unit 801 embeds the emulator code in an I/O emulator code and activates an I/O emulator based on the I/O emulator code. Thus, the VM activation unit 801 can cause an I/O emulator 930 to start executing a VM code.

The LM execution unit 802 starts live migration of the VM 110 to another computer in response to reception of an instruction for the live migration of the VM 110 in which the emulator 111 is embedded. The other computer is a computer that includes an FPGA 140 which is the same as the FPGA 120 included in the information processing apparatus 100. The other computer is, for example, the movement destination apparatus 130 illustrated in FIG. 2. The other computer may not include the FPGA 140 which is the same as the FPGA 120 included in the information processing apparatus 100.

For example, the LM execution unit 802 starts copying information regarding the VM 110 to the movement destination apparatus 130 by transmitting the state of the VM 110 to the movement destination apparatus 130. The information regarding the VM 110 is a state of the VM 110. The state is a status of a memory or a register included in the information processing apparatus 100. Specifically, the LM execution unit 802 copies the state of the VM 110 to the movement destination apparatus 130 and further copies a difference in the state to the movement destination apparatus 130 in a case in which the state of the VM 110 is changed during the copying. Thus, the LM execution unit 802 copies the state of the VM 110 to the movement destination apparatus 130 so that the movement destination apparatus 130 can take over the VM 110.

The LM execution unit 802 determines whether the degree of progress taken to transmit data of the live migration of the VM 110 satisfies the first condition. When the first condition is satisfied, the LM execution unit 802 switches the VM 110 from the status in which the FPGA 120 is caused to execute a process to a status in which the emulator 111 of the FPGA 120 is caused to execute the process.

The degree of progress is expressed by, for example, a ratio of the state transmitted to the movement destination apparatus 130 to the state of the VM 110. The degree of progress may be expressed by, for example, a time remaining until completion of transmission of the state of the VM 110. The first condition is a condition that there is an opportunity to switch from a status in which the FPGA 120 is caused to execute a process to a status in which the emulator 111 of the FPGA 120 is caused to execute the process. The first condition is, for example, a condition that the live migration of the VM 110 is being executed. The first condition may be, for example, a condition that a ratio of the state transmitted to another computer to the state of the VM 110 is equal to or greater than a predetermined threshold. The first condition may be, for example, a condition that a time remaining until completion of transmission of the state of the VM 110 to another computer is equal to or less than a predetermined threshold.

For example, the LM execution unit 802 switches the VM 110 from a status in which the FPGA 120 is caused to execute the process to the status in which the emulator 111 of the FPGA 120 is caused to execute the process in response to start of the live migration. Specifically, the LM execution unit 802 switches the mode of the FPGA execution mode table 700 illustrated in FIG. 7 from a hardware execution mode to an emulator execution mode in response to the start of the live migration.

Thus, the LM execution unit 802 can allow the FPGA 120 not to be used earlier than switching of the computer executing the VM 110 so that the FPGA 120 is not being used at the time of switching the computer executing the VM 110.

The LM execution unit 802 determines whether the degree of progress taken to transmit data of the live migration of the VM 110 satisfies the second condition. The LM execution unit 802 determines whether the FPGA 120 is executing the process on the VM 110. When the second condition is satisfied and the FPGA 120 is not executing the process on the VM 110, the LM execution unit 802 switches the computer executing the VM 110 to another computer.

The second condition is a condition that the computer executing the VM 110 is switched and is a condition that there is an opportunity to complete transmission of the information regarding the VM 110. The second condition is, for example, a condition that a ratio of the state transmitted to the other computer to the state of the VM 110 is equal to or greater than a predetermined threshold. The second condition is a condition that a time remaining until completion of the transmission of the state of the VM 110 to the other computer is equal to or less than a predetermined threshold.

For example, in a case in which the ratio of the state transmitted to the movement destination apparatus 130 to the state of the VM 110 is equal to or greater than the predetermined threshold, the LM execution unit 802 determines that the second condition is satisfied. In a case in which the accelerator realized by the FPGA 120 does not execute a process with reference to the FPGA execution status table 600 illustrated in FIG. 6, the LM execution unit 802 determines that the FPGA 120 is not executing the process on the VM 110. When the second condition is satisfied and the FPGA 120 is not executing the process on the VM 110, the LM execution unit 802 switches the computer executing the VM 110 to the movement destination apparatus 130.

Thus, the LM execution unit 802 switches the computer executing the VM 110 when the FPGA 120 is not being used. Thus, in the movement destination apparatus 130, the VM 110 may not acquire a process result of the FPGA 120. As a result, the LM execution unit 802 can suppress occurrence of a trouble in which the VM 110 does not acquire a process result in the movement destination apparatus 130 from the FPGA 120, and thus it is possible to suppress occurrence of the trouble of the VM 110 in the movement destination apparatus 130.

When the degree of progress taken to transmit data of the live migration of the VM 110 satisfies the first condition, the FPGA access processing unit 803 causes the emulator 111 to execute a process requested from the VM 110 to the FPGA 120. For example, when the emulator execution mode is set as the mode of the FPGA execution mode table 700 illustrated in FIG. 7, the FPGA access processing unit 803 causes the emulator 111 to execute the process requested from the VM 110 to the FPGA 120.

Thus, the FPGA access processing unit 803 can allow the FPGA 120 not to be used at the time of switching the computer executing the VM 110. Specifically, the FPGA access processing unit 803 can allow the FPGA 120 not to be used earlier than switching of the computer executing the VM 110.

When the degree of progress taken to transmit data of the live migration of the VM 110 does not satisfy the first condition, the FPGA access processing unit 803 causes the FPGA 120 to execute the process requested from the VM 110 to the FPGA 120. For example, the hardware execution mode is set as the mode of the FPGA execution mode table 700 illustrated in FIG. 7, the FPGA access processing unit 803 causes the FPGA 120 to execute the process requested from the VM 110 to the FPGA 120.

Thus, before the degree of progress taken to transmit data of the live migration of the VM 110 satisfies the first condition, the FPGA access processing unit 803 can cause the FPGA 120 to execute the process requested from the VM 110 to the FPGA 120 without change. Then, the FPGA access processing unit 803 can reduce the number of times the emulator 111 for which a time taken to execute a process is easily longer than the FPGA 120 is caused to execute the process requested from the VM 110 to the FPGA 120. As a result, the FPGA access processing unit 803 can suppress the deterioration in the performance of the VM 110.

In a case in which the FPGA 120 is caused to execute the process, the FPGA access processing unit 803 sets “1” in the exec flag corresponding to the accelerator used for the process which the FPGA 120 is caused to execute in the FPGA execution status table 600 illustrated in FIG. 6. Thereafter, in a case in which the FPGA 120 ends the process, the FPGA access processing unit 803 returns the exec flag corresponding to the accelerator used for the process ended by the FPGA 120 to “0” in the FPGA execution status table 600 illustrated in FIG. 6. Thus, the FPGA access processing unit 803 can determine whether the FPGA 120 is executing the process on the VM 110.

Module Configuration Example of Information Processing Apparatus 100 in Example 1

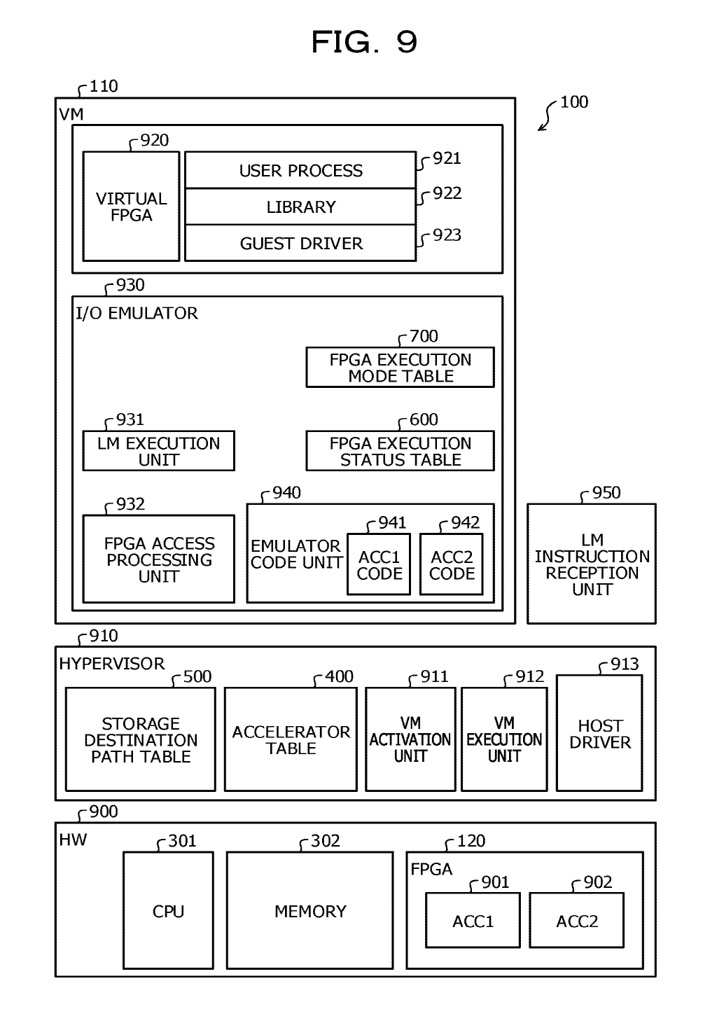

Next, a module configuration example of the information processing apparatus 100 in Example 1 in which a function of the control unit illustrated in FIG. 8 is specifically realized will be described with reference to FIG. 9.

FIG. 9 is an explanatory diagram illustrating the module configuration example of the information processing apparatus 100 according to Example 1. In the example of FIG. 9, hardware 900 of the information processing apparatus 100 includes the CPU 301, the memory 302, and the FPGA 120 illustrated in FIG. 3. The FPGA 120 realizes accelerators 901, 902, and the like to which the ACC IDs “ACC1 and ACC2” or the like are allocated. In the hardware 900, a hypervisor 910 is operating. The hypervisor 910 includes the accelerator table 400 illustrated in FIG. 4 or the storage destination path table 500 illustrated in FIG. 5. The hypervisor 910 further includes a VM activation unit 911, a VM execution unit 912, and a host driver 913.

In the hypervisor 910, an LM instruction reception unit 950 and the VM 110 operate. The VM 110 includes a virtual FPGA 920, a user process 921, a library 922, and a guest driver 923. The virtual FPGA 920 includes an I/O emulator 930. The I/O emulator 930 includes the FPGA execution status table 600 illustrated in FIG. 6 and the FPGA execution mode table 700 illustrated in FIG. 7. The I/O emulator 930 further includes an LM execution unit 931, an FPGA access processing unit 932, and an emulator code unit 940.

Referring to the accelerator table 400 illustrated in FIG. 4 or the storage destination path table 500 illustrated in FIG. 5, the VM activation unit 911 can embed the emulator 111 corresponding to the accelerator in the I/O emulator 930 included in the VM 110 at the time of activating the VM 110. For example, the VM activation unit 911 corresponds to the VM activation unit 801 illustrated in FIG. 8. The VM execution unit 912 can execute a VM code. The host driver 913 controls access to the FPGA 120 to cause the FPGA 120 to execute a process.

The LM instruction reception unit 950 can receive a manipulation input for a live migration request from a user and transmit the live migration request to the LM execution unit 931. The user process 921 is a process which is executed by an operating system (OS) of the VM 110. The library 922 is a program which is used by the OS of the VM 110. The guest driver 923 is a driver which is used by the OS of the VM 110.

The LM execution unit 931 executes the live migration. Referring to the FPGA execution status table 600 illustrated in FIG. 6, the LM execution unit 931 switches the computer executing the VM 110 when the FPGA 120 is not executing the process on the VM 110. The LM execution unit 931 corresponds to the LM execution unit 802 illustrated in FIG. 8.

Referring to the FPGA execution mode table 700 illustrated in FIG. 7, the FPGA access processing unit 932 switches whether the accelerators 901 and 902 or the like are caused to execute the process requested from the VM 110 to the FPGA 120. The FPGA access processing unit 932 corresponds to the FPGA access processing unit 803 illustrated in FIG. 8. The emulator code unit 940 can execute the emulator 111 based on the emulator code.

Example of Flow of Operation of Information Processing Apparatus 100 according to Example 1

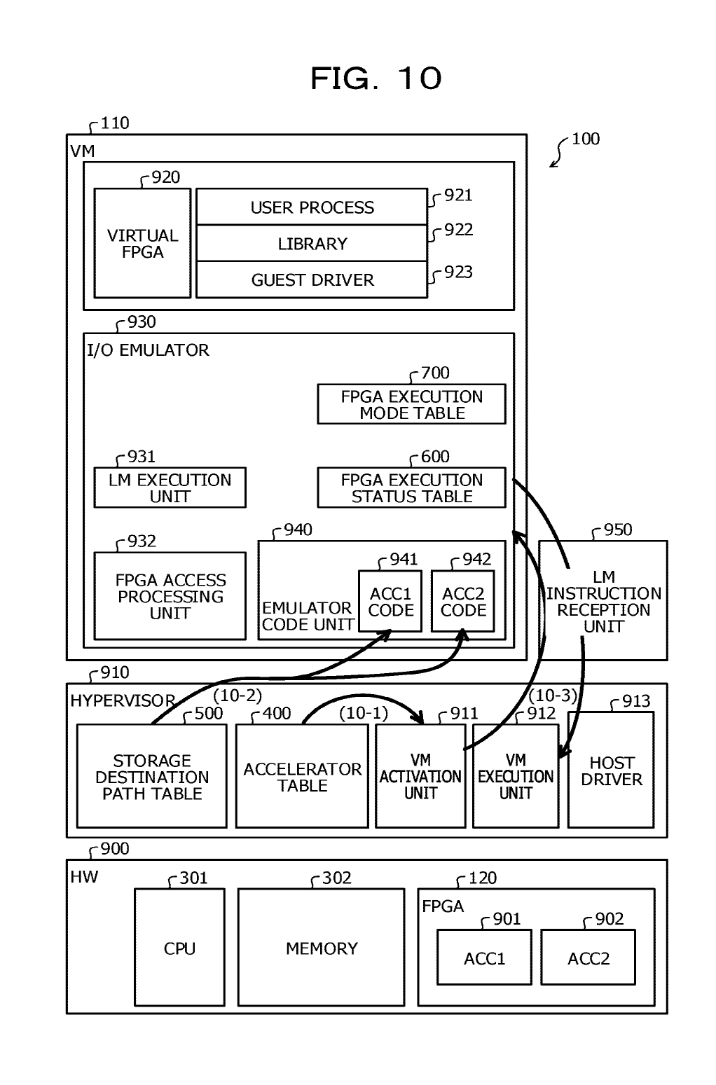

Next, an example of the flow of an operation of the information processing apparatus 100 according to Example 1 will be described with reference to FIGS. 10 to 13.

FIGS. 10 to 13 are explanatory diagrams illustrating the example of the flow of the operation of the information processing apparatus 100 according to Example 1. Specifically, FIG. 10 illustrates an example of the flow of an operation in which the information processing apparatus 100 activates the VM 110. In the example of FIG. 10, (10-1) the VM activation unit 911 reads the ACC IDs “ACC1 and ACC2” of the accelerators 901 and 902 realized by the FPGA 120 with reference to the accelerator table 400 illustrated in FIG. 4.

(10-2) The VM activation unit 911 reads bitfile paths corresponding to the read ACC IDs “ACC 1 and ACC2” with reference to the storage destination path table 500 illustrated in FIG. 5. The VM activation unit 911 reads the emulator codes corresponding to the accelerators 901 and 902 from the memory regions indicated by the read bitfile paths “/var/lib/bitfile/acc1 and /var/lib/bitfile/acc2”.

The VM activation unit 911 embeds emulator codes 941 and 942 corresponding to the read accelerators 901 and 902 in the I/O emulator codes and activates the I/O emulator 930 based on I/O emulator codes. Thus, the emulator code unit 940 included in the I/O emulator 930 can store the emulator codes 941 and 942 corresponding to the accelerators 901 and 902.

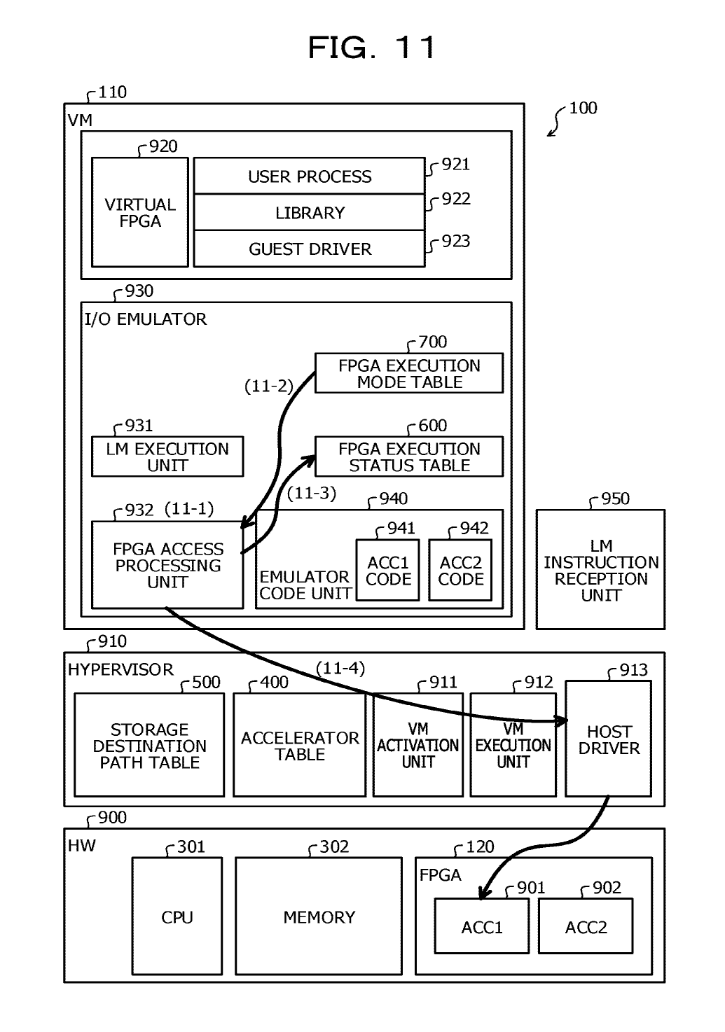

(10-3) When the I/O emulator 930 is activated, the I/O emulator 930 causes the VM execution unit 912 to execute a VM code by issuing a system call to the VM execution unit 912. Thus, the information processing apparatus 100 can activate the VM 110. Next, the description of FIG. 11 will be made.

Specifically, FIG. 11 illustrates an example of the flow of an operation in which the information processing apparatus 100 causes the FPGA 120 to execute a process. In the example of FIG. 11, (11-1) the FPGA access processing unit 932 receives a process which is requested from the VM 110 to the FPGA 120 and using one accelerator.

(11-2) The FPGA access processing unit 932 determines whether the mode is the hardware execution mode or the emulator execution mode with reference to the FPGA execution mode table 700 illustrated in FIG. 7. Here, the FPGA access processing unit 932 determines that the mode is the hardware execution mode.

(11-3) Since the FPGA access processing unit 932 determines that the mode is the hardware execution mode, the FPGA access processing unit 932 sets “1” in the exec flag corresponding to the accelerator used for the process which the FPGA 120 is caused to execute in the FPGA execution status table 600 illustrated in FIG. 6.

(11-4) The FPGA access processing unit 932 causes the FPGA 120 to execute the process using one accelerator. For example, the FPGA access processing unit 932 issues a system call to the FPGA 120 via the host driver 913 in regard to the process using one accelerator. The FPGA access processing unit 932 waits for completion or the like of the system call and detects that the FPGA 120 ends the process.

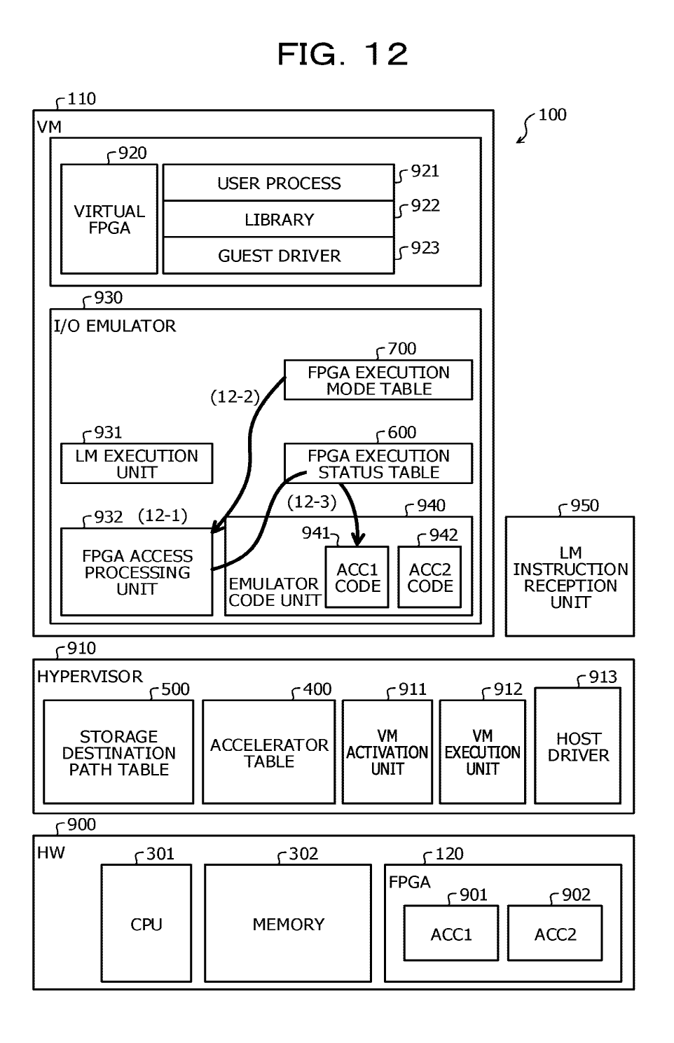

Thereafter, in a case in which the FPGA 120 ends the process, the FPGA access processing unit 932 receives a process result and outputs the process result to the VM 110. In a case in which the FPGA 120 ends the process, the FPGA access processing unit 932 returns the exec flag corresponding to the accelerator used for the process ended by the FPGA 120 in the FPGA execution status table 600 illustrated in FIG. 6 to “0”. Next, description of FIG. 12 will be made.

FIG. 12 specifically illustrates an example of the flow of the operation in which the information processing apparatus 100 causes the emulator to execute a process. In the example of FIG. 12, (12-1) the FPGA access processing unit 932 receives the process requested from the VM 110 to the FPGA 120 and using one accelerator.

(12-2) The FPGA access processing unit 932 determines whether the mode is the hardware execution mode or the emulator execution mode with reference to the FPGA execution mode table 700 illustrated in FIG. 7. Here, the FPGA access processing unit 932 determines that the mode is the emulator execution mode.

(12-3) Since the FPGA access processing unit 932 determines that the mode is the emulator execution mode, the FPGA access processing unit 932 specifies the accelerator used for the process requested from the VM 110 to the FPGA 120. The FPGA access processing unit 932 transmits an execution request to the emulator code unit 940 so that the process requested from the VM 110 to the FPGA 120 is executed using the emulator 111 corresponding to the specified accelerator.

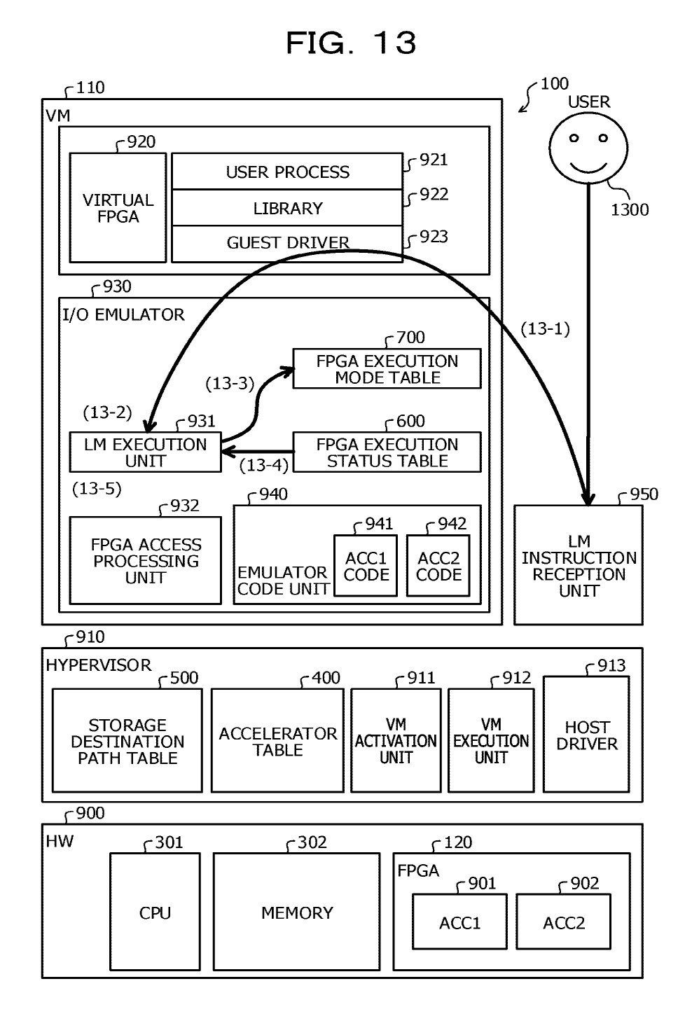

Thereafter, in a case in which the FPGA 120 ends the process, the FPGA access processing unit 932 receives the process result and outputs the process result to the VM 110. Thus, the information processing apparatus 100 can allow the FPGA 120 not to be used earlier than switching of the computer executing the VM 110 so that the FPGA 120 is not being used at the time of switching the computer executing the VM 110. Next, description of FIG. 13 will be made.

Specifically, FIG. 13 illustrates the example of the flow of an operation in which the information processing apparatus 100 executes the live migration. In the example of FIG. 13, (13-1) the LM instruction reception unit 950 receives a manipulation input for a live migration request from a user 1300 and transmits the live migration request to the LM execution unit 931. The LM execution unit 931 receives the live migration request.

(13-2) The LM execution unit 931 starts copying the state of the VM 110 to the movement destination apparatus 130 by starting transmission of the state of the VM 110 to the movement destination apparatus 130. In a case in which the state is changed during the transmission, the LM execution unit 931 further transmits a difference in the state to the movement destination apparatus 130.

(13-3) The LM execution unit 931 switches the VM 110 from a status in which the FPGA 120 is caused to execute a process to a status in which the emulator 111 of the FPGA 120 is caused to execute the process in response to start of the live migration. Specifically, the LM execution unit 931 switches the mode of the FPGA execution mode table 700 illustrated in FIG. 7 from the hardware execution mode to the emulator execution mode.

Thus, the LM execution unit 931 can allow the FPGA 120 not to be used earlier than switching of the computer executing the VM 110 so that the FPGA 120 is not being used at the time of switching the computer executing the VM 110.

(13-4) The LM execution unit 931 determines whether the ratio of the state transmitted to the movement destination apparatus 130 to the state of the VM 110 is equal to or greater than the predetermined threshold. In a case in which the ratio is equal to or greater than the predetermined threshold, the LM execution unit 931 determines whether the FPGA 120 is executing the process on the VM 110 with reference to the FPGA execution status table 600 illustrated in FIG. 6.

(13-5) When the FPGA 120 is not executing the process on the VM 110, the LM execution unit 931 switches the computer executing the VM 110 to the movement destination apparatus 130. When the FPGA 120 is executing the process on the VM 110, the LM execution unit 931 waits for a predetermined time without switching the computer executing the VM 110 and return the process to (13-4). After completion of the live migration, the LM execution unit 931 returns the mode of the FPGA execution mode table 700 illustrated in FIG. 7 to the hardware execution mode in the movement destination apparatus 130.

Thus, the LM execution unit 931 switches the computer executing the VM 110 when the FPGA 120 is not being used. Thus, in the movement destination apparatus 130, the VM 110 may not acquire a process result of the FPGA 120. As a result, the LM execution unit 931 can suppress occurrence of a trouble in which the VM 110 does not acquire a process result in the movement destination apparatus 130 from the FPGA 120, and thus it is possible to suppress occurrence of the trouble of the VM 110 in the movement destination apparatus 130.

Example of Flow of Live Migration in Example 1

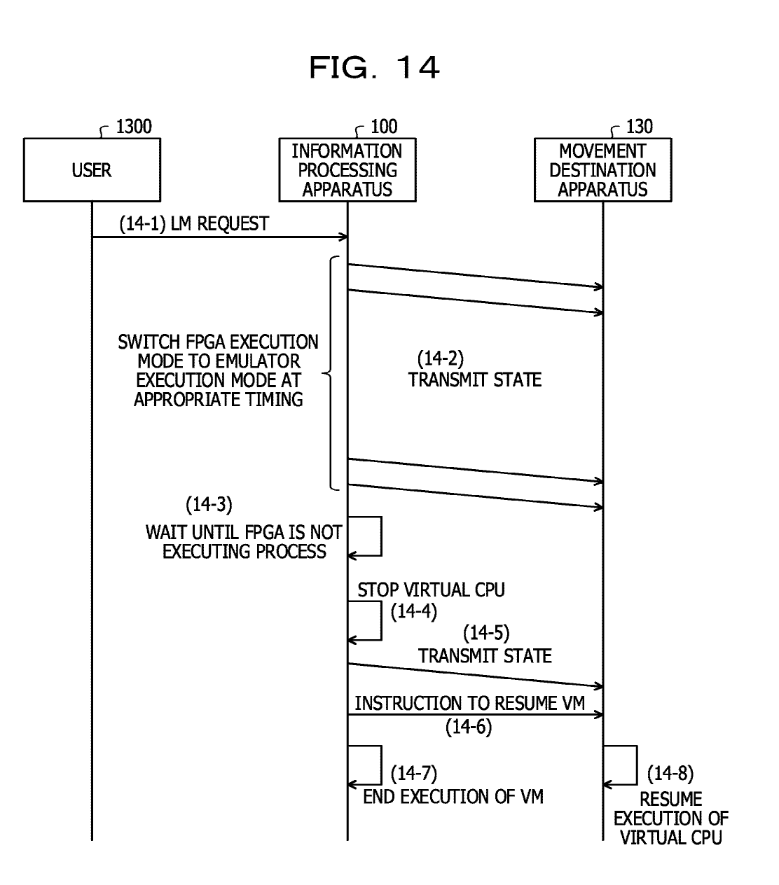

Next, an example of the flow of the live migration in Example 1 will be described with reference to FIG. 14.

FIG. 14 is an explanatory diagram illustrating an example of the flow of the live migration according to Example 1. In an example of FIG. 14, (14-1) a live migration request is input to the information processing apparatus 100 in response to a manipulation input from the user 1300.

(14-2) The information processing apparatus 100 transmits the state of the VM 110 to the movement destination apparatus 130. In a case in which the state is changed during the transmission, the information processing apparatus 100 further transmit a difference in the state to the movement destination apparatus 130. At this time, the information processing apparatus 100 switches the VM 110 from the status in which the FPGA 120 is caused to execute the process to the status in which the emulator 111 of the FPGA 120 is caused to execute the process at any timing during the transmission.

(14-3) The information processing apparatus 100 determines whether the ratio of the state transmitted to the movement destination apparatus 130 to the state of the VM 110 is equal to or greater than the predetermined threshold. In a case in which the ratio of the state transmitted to the movement destination apparatus 130 to the state of the VM 110 is equal to or greater than the predetermined threshold, the information processing apparatus 100 waits until the FPGA 120 does not execute the process on the VM 110 with reference to the FPGA execution status table 600 illustrated in FIG. 6.

(14-4) When the ratio of the state transmitted to the movement destination apparatus 130 to the state of the VM 110 is equal to or greater than the predetermined threshold and the FPGA 120 is not executing the process on the VM 110, the information processing apparatus 100 stops the virtual CPU of the VM 110.

(14-5) When there is the state of the VM 110 not transmitted and remaining in the state of the VM 110, the information processing apparatus 100 transmits the remaining state of the VM 110 to the movement destination apparatus 130.

(14-6) The information processing apparatus 100 transmits an instruction to resume the VM 110 to the movement destination apparatus 130.

(14-7) When the information processing apparatus 100 transmits the instruction to resume the VM 110, the self-apparatus ends the execution of the VM 110.

(14-8) When the movement destination apparatus 130 receives the instruction to resume the VM 110, the movement destination apparatus 130 resumes execution of the virtual CPU of the VM 110 and executes the VM 110. Thus, the information processing apparatus 100 can execute the live migration so that a trouble does not occur in the VM 110 in the movement destination apparatus 130.

Example of VM Activation Process Procedure in Example 1

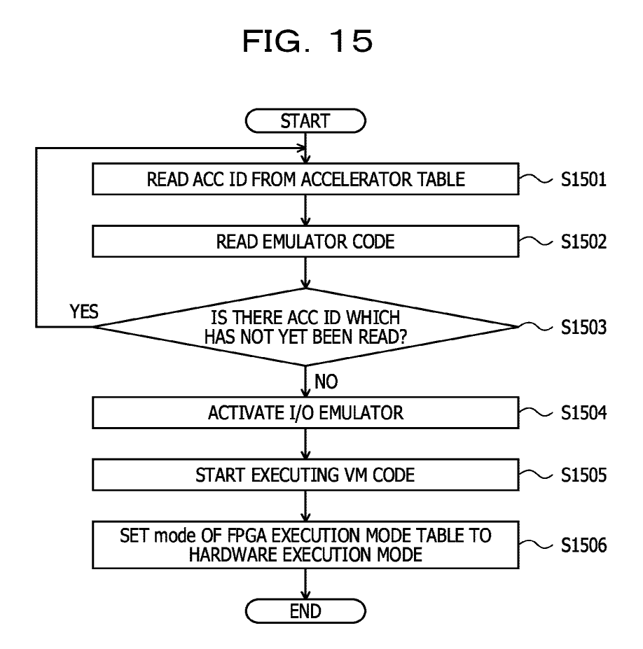

Next, an example of a VM activation process procedure in Example 1 will be described with reference to FIG. 15.

FIG. 15 is a flowchart illustrating an example of a VM activation process procedure according to Example 1. In FIG. 15, the VM activation unit 911 reads the ACC ID which has not yet been read from the accelerator table 400 (step S1501). Next, the VM activation unit 911 reads the bitfile path corresponding to the read ACC ID from the storage destination path table 500 and reads the emulator code based on the read bitfile path (step S1502).

Then, the VM activation unit 911 determines whether there is the ACC ID which has not yet been read (step S1503). Here, in a case in which there is the ACC ID which has not yet been read (Yes in step S1503), the VM activation unit 911 returns the process to step S1501.

Conversely, in a case in which there is no ACC ID which has not yet been read (No in step S1503), the VM activation unit 911 embeds the read emulator code in the I/O emulator code and activates the I/O emulator 930 (step S1504). Here, the I/O emulator 930 causes the VM execution unit 912 to start executing the VM code (step S1505).

Then, the VM activation unit 911 sets the mode of the FPGA execution mode table 700 to the hardware execution mode (step S1506). The VM activation unit 911 ends the VM activation process procedure. Thus, the VM activation unit 911 can activate the VM 110 in which the trouble rarely occurs in the movement destination apparatus 130 even when the emulator 111 is embedded and the live migration is executed.

Example of Hardware Access Process Procedure in Example 1

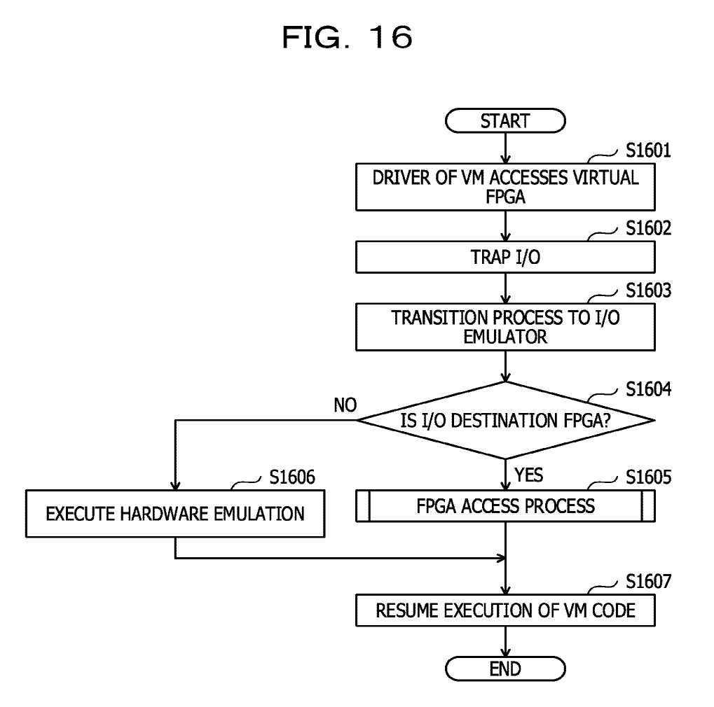

Next, an example of a hardware access process procedure in Example 1 will be described with reference to FIG. 16.

FIG. 16 is a flowchart illustrating an example of the hardware access process procedure according to Example 1. In FIG. 16, a driver of the VM 110 accesses the virtual FPGA 920 (step S1601). The hypervisor 910 traps I/O by generating VM EXIT (step S1602). The hypervisor 910 transitions the process to the I/O emulator 930 (step S1603).

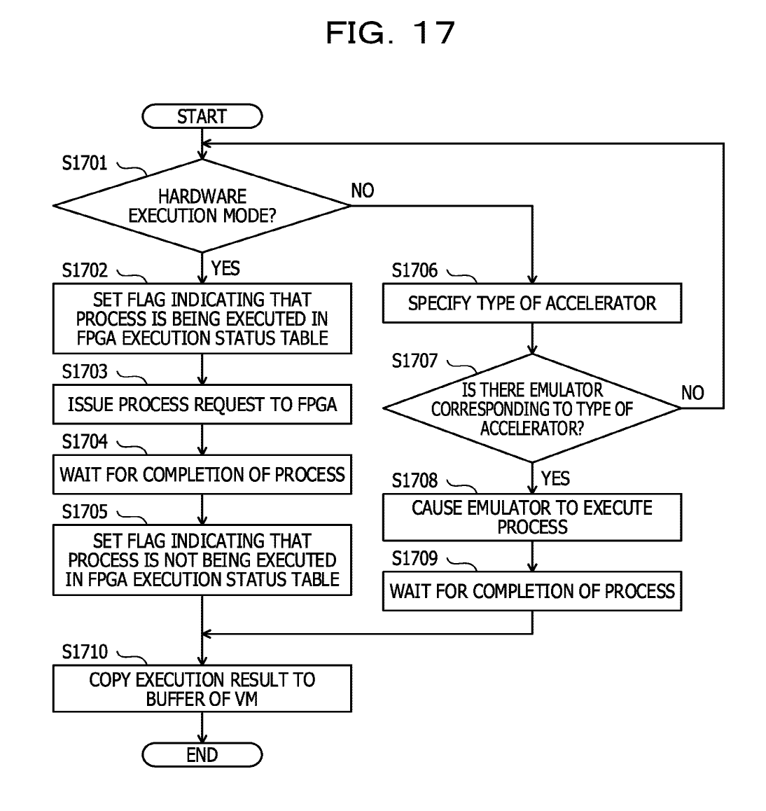

The FPGA access processing unit 932 of the I/O emulator 930 determines whether an I/O destination is the FPGA 120 (step S1604). Here, in a case in which the I/O destination is the FPGA 120 (Yes in step S1604), the FPGA access processing unit 932 executes an FPGA access process illustrated in FIG. 17 (step S1605) and transitions the process to step S1607.

Conversely, in a case in which the I/O destination is not the FPGA 120 (No in step S1604), the FPGA access processing unit 932 executes hardware emulation corresponding to hardware other than the FPGA 120 which is the I/O destination (step S1606). Then, the FPGA access processing unit 932 transitions the process to step S1607.

In step S1607, the FPGA access processing unit 932 generates VM ENTRY and causes the VM execution unit 912 to resume the execution of the VM code (S1607). Then, the information processing apparatus 100 ends the hardware access process. Thus, the information processing apparatus 100 can determine whether the FPGA 120 is caused to execute the process or the emulator 111 is caused to execute the process.

Example of FPGA Access Process Procedure in Example 1

Next, an example of an FPGA access process procedure in Example 1 will be described with reference to FIG. 17.

FIG. 17 is a flowchart illustrating an example of an FPGA access process procedure according to Example 1. The FPGA access processing unit 932 determines whether the mode of the FPGA execution mode table 700 is the hardware execution mode in FIG. 17 (step S1701). Here, in a case in which the mode is the hardware execution mode (Yes in step S1701), the FPGA access processing unit 932 transitions the process to step S1702.

In step S1702, the FPGA access processing unit 932 sets a flag indicating that the process is being executed in the exec flag corresponding to the accelerator used for the process in the FPGA execution status table 600 (step S1702). Next, the FPGA access processing unit 932 issues a process request for the process using the accelerator to the FPGA 120 (step S1703). Then, the FPGA access processing unit 932 waits for completion of the process (step S1704).

Thereafter, when the process is completed, the FPGA access processing unit 932 sets a flag indicating that the process is not being executed in the exec flag corresponding to the accelerator used for the process in the FPGA execution status table 600 (step S1705). Then, the FPGA access processing unit 932 transitions the process to step S1710.

Conversely, in a case in which the mode is not the hardware execution mode (No in step S1701), the FPGA access processing unit 932 specifies the type of accelerator used for the process from content of the process (step S1706). Subsequently, the FPGA access processing unit 932 determines whether there is the emulator code corresponding to the specified type of accelerator (step S1707). Here, in a case in which there is no emulator code (No in step S1707), the FPGA access processing unit 932 returns the process to step S1701.

Conversely, in a case in which there is the emulator code (Yes in step S1707), the FPGA access processing unit 932 causes the emulator 111 corresponding to the specified type of accelerator to execute the process (step S1708). Subsequently, the FPGA access processing unit 932 waits for completion of the process (step S1709). Thereafter, when the process is completed, the FPGA access processing unit 932 transitions the process to step S1710.

In step S1710, the FPGA access processing unit 932 copies an execution result of the process using the accelerator to a buffer of the VM 110 (step S1710). Then, the FPGA access processing unit 932 ends the FPGA access process. Thus, the information processing apparatus 100 can efficiently execute the process using the FPGA 120. The information processing apparatus 100 can operate the VM 110 in a status in which the trouble does not occur in the movement destination apparatus 130 even when the live migration is executed.

Example of LM Execution Process Procedure in Example 1

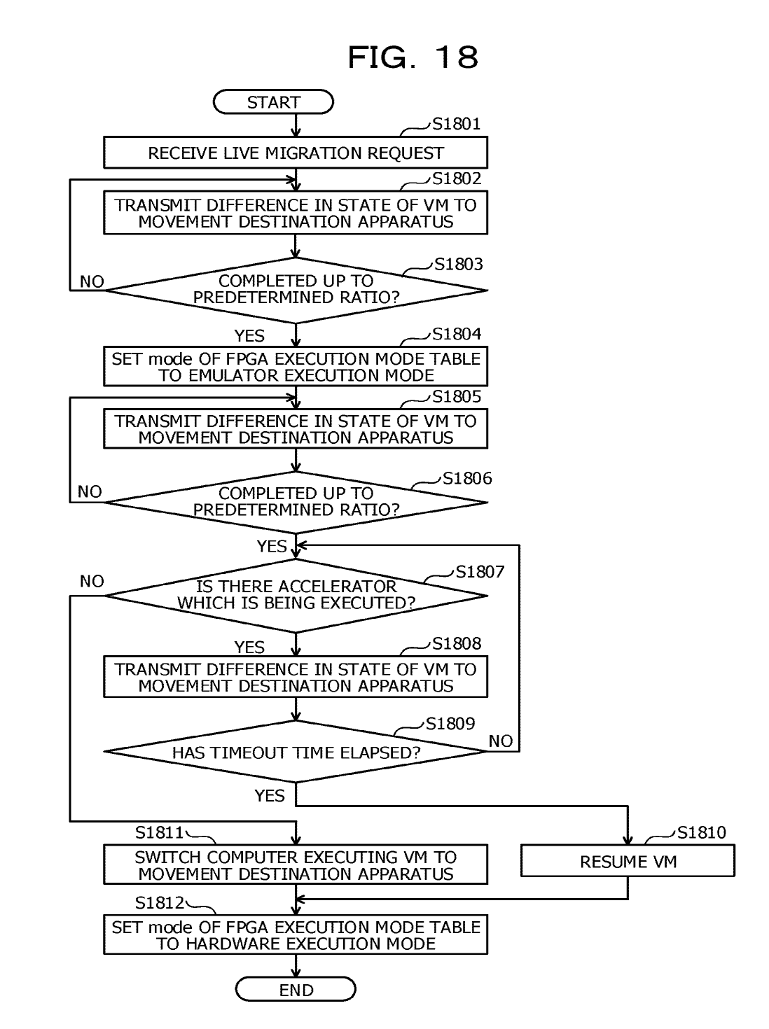

Next, an example of an LM execution process procedure in Example 1 will be described with reference to FIG. 18.

FIG. 18 is a flowchart illustrating an example of an LM execution process procedure according to Example 1. In FIG. 18, the LM execution unit 931 receives a live migration request (step S1801). Next, the LM execution unit 931 transmits the difference in the state of the VM 110 to the movement destination apparatus 130 (step S1802). Then, the LM execution unit 931 determines whether the transmission of the state of the VM 110 is completed up to a predetermined ratio (step S1803). Here, in a case in which the transmission is not completed (No in step S1803), the LM execution unit 931 returns the process to step S1802.

Conversely, in a case in which the transmission is completed (Yes in step S1803), the LM execution unit 931 sets the mode of the FPGA execution mode table 700 to the emulator execution mode (step S1804). Subsequently, the LM execution unit 931 transmits the difference in the state of the VM 110 to the movement destination apparatus 130 (step S1805). Then, the LM execution unit 931 determines whether the transmission of the state of the VM 110 is completed up to a predetermined ratio (step S1806). Here, in a case in which the transmission is not completed (No in step S1806), the LM execution unit 931 returns the process to step S1805.

Conversely, in a case in which the transmission is completed (Yes in step S1806), the LM execution unit 931 determines whether there is the accelerator which is being executed based on the FPGA execution status table 600 (step S1807). Here, in a case in which there is the accelerator which is being executed (Yes in step S1807), the LM execution unit 931 transmits the difference in the state of the VM 110 to the movement destination apparatus 130 (step S1808).

Next, it is determined whether a timeout time has elapsed from LM start (step S1809). Here, in a case in which the timeout time has not elapsed (No in step S1809), the LM execution unit 931 returns the process to step S1807.

Conversely, in a case in which the timeout time has elapsed (Yes in step S1809), the LM execution unit 931 notifies of a failure of the live migration, stops the live migration, and resumes the VM 110 (step S1810). Then, the LM execution unit 931 transitions the process to step S1812.

Conversely, in a case in which there is no accelerator which is being executed (No in step S1807), the LM execution unit 931 temporarily stops the VM 110 and switches the computer executing the VM 110 to the movement destination apparatus 130 (step S1811). Then, the LM execution unit 931 transitions the process to step S1812.

In step S1812, the LM execution unit 931 sets the ode of the FPGA execution mode table 700 to the hardware execution mode (step S1812). Then, the LM execution unit 931 ends the LM execution process. Thus, the information processing apparatus 100 can execute the live migration so that occurrence of a trouble of the VM 110 in the movement destination apparatus 130 is suppressed.

Example 2 in Live Migration

Next, Example 2 will be described. As described above, Example 2 is an example in which whether the FPGA 120 is executed to execute a process or the emulator 111 of the FPGA 120 is caused to execute a process is switched at a timing different for each kind of accelerator used for the process requested from the VM 110 to the FPGA 120.

Memory Content of Accelerator Table 400 in Example 2

Since memory content of the accelerator table 400 in Example 2 is the same as the memory content of the accelerator table 400 in Example 1 illustrated in FIG. 4, the description thereof will be omitted.

Memory Content of Storage Destination Path Table 500 in Example 2

Since memory content of the storage destination path table 500 in Example 2 is the same as the memory content of the storage destination path table 500 in Example 1 illustrated in FIG. 5, the description thereof will be omitted.

Memory Content of FPGA Execution Status Table 600 in Example 2

Since memory content of the FPGA execution status table 600 in Example 2 is the same as the memory content of the FPGA execution status table 600 in Example 1 illustrated in FIG. 6, the description thereof will be omitted.

Memory Content of FPGA Execution Mode Table 1900 in Example 2

Memory content of an FPGA execution mode table 1900 in Example 2 is different from that of the FPGA execution mode table 700 illustrated in FIG. 7 in Example 1 and is memory content in which information is set in each field for each accelerator realized by the FPGA 120.

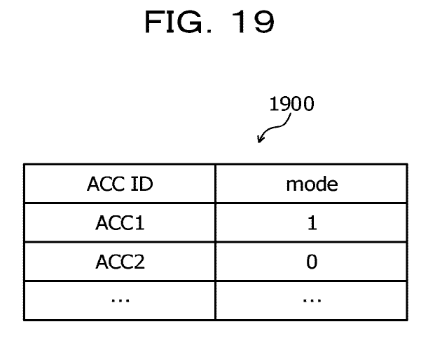

Here, an example of memory content of the FPGA execution mode table 1900 in Example 2 stored in the information processing apparatus 100 will be described with reference to FIG. 19. For example, the FPGA execution mode table 1900 is realized by a memory region of the memory 302, the disc driver 304, or the like of the information processing apparatus 100 illustrated in FIG. 3.

FIG. 19 is an explanatory diagram illustrating an example of memory content of an FPGA execution mode table 1900 according to Example 2. As illustrated in FIG. 19, the FPGA execution mode table 1900 has fields of an ACC ID and a mode. In the FPGA execution mode table 1900, execution mode information of each accelerator is stored as a record by setting information in each field for the FPGA 120 for each accelerator realized by the FPGA 120.

In the field of the ACC ID, identification information for uniquely specifying the accelerator realized by the FPGA 120 is set. In the field of the mode, a mode indicating whether an accelerator realized by the FPGA 120 is caused to execute the process on the VM 110 or the emulator 111 corresponding to an accelerator realized by the FPGA 120 is caused to execute the process is set. For example, the mode is “1” in a case in which the accelerator is caused to execute the process, and is “0” in a case in which the emulator 111 is caused to execute the process. In this way, the FPGA execution mode table 1900 enables whether the accelerator is caused to execute the process on the VM 110 or the emulator 111 is caused to execute the process to be determined.

Memory Content of Mode Switch Timing Table 2000 in Example 2

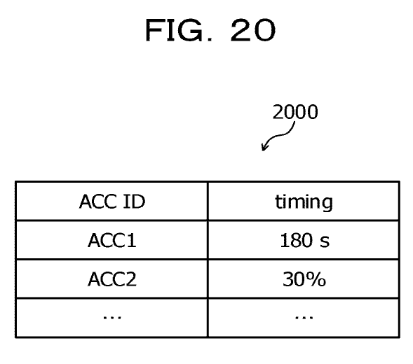

Next, an example of memory content of a mode switch timing table 2000 stored in the information processing apparatus 100 in Example 2 will be described with reference to FIG. 20. For example, the mode switch timing table 2000 is realized by a memory region of the memory 302, the disc driver 304, or the like of the information processing apparatus 100 illustrated in FIG. 3.

FIG. 20 is an explanatory diagram illustrating an example of memory content of a mode switch timing table 2000 according to Example 2. As illustrated in FIG. 20, the mode switch timing table 2000 has fields of an ACC ID and a timing. In the mode switch timing table 2000, switch timing information is stored as a record by setting information in each field in the FPGA 120.

In the field of the ACC ID, identification information for uniquely specifying the accelerator realized by the FPGA 120 is set. In the field of the timing, a switch timing indicating a chance whether to switch between execution of the process on the VM 110 by the accelerator and execution of the process by the emulator 111 is set. For example, the switch timing is expressed by a time remaining until the live migration is completed. For example, the switch timing may be expressed by a ratio of the state of the VM 110 transmitted to the movement destination apparatus 130 to the state of the VM 110. In this way, the mode switch timing table 2000 enables whether the accelerator is caused to execute the process on the VM 110 or the emulator 111 is caused to execute the process and enables a switching time to be specified.

Functional Configuration Example of Information Processing Apparatus 100 in Example 2

Next, a functional configuration example of the information processing apparatus 100 in Example 2 will be described. A functional configuration example of the information processing apparatus 100 in Example 2 is the same as the functional configuration example of the information processing apparatus 100 illustrated in FIG. 8 in Example 1. In other words, the information processing apparatus 100 is configured to include a VM activation unit 801, an LM execution unit 802, and an FPGA access processing unit 803.

As in Example 1, the VM activation unit 801 embeds the emulator 111 which becomes a substitute of hardware capable of dynamically defining a function in the VM 110 at the time of activating the VM 110. Thus, the VM activation unit 801 can cause the I/O emulator 930 to start executing a VM code.

As in Example 1, the LM execution unit 802 starts the live migration of the VM 110 to another computer in response to reception of an instruction of the live migration of the VM 110 in which the emulator 111 is embedded.

Unlike Example 1, the LM execution unit 802 determines whether the degree of progress taken to transmit data of the live migration of the VM 110 in each of a plurality of functions of hardware capable of dynamically defining a function with reference to association information satisfies the first condition. The function is, for example, an accelerator. The association information is information in which the first condition is associated with each of the plurality of the functions of the hardware capable of dynamically defining a function. The association information is, for example, the mode switch timing table 2000 illustrated in FIG. 20.

For example, the VM execution unit 912 determines whether the degree of progress taken to transmit data of the live migration of the VM 110 satisfies the first condition corresponding to the accelerator for each accelerator realized by the VM 110. Then, the LM execution unit 802 causes the emulator 111 to execute the process using the accelerator that satisfies the first condition instead of the accelerator realized by the FPGA 120. The first condition is, for example, a switch timing of each accelerator stored in the mode switch timing table 2000 illustrated in FIG. 20.

Specifically, the LM execution unit 802 reads a switch timing of each accelerator with reference to the mode switch timing table 2000 illustrated in FIG. 20. The LM execution unit 802 causes the emulator 111 corresponding to the accelerator to execute the process in response to a chance indicated by the read switch timing for each accelerator.

More specifically, the LM execution unit 802 switches the mode of the FPGA execution mode table 1900 illustrated in FIG. 19 and corresponding to the accelerator to the emulator execution mode in response to the chance indicated by the read switch timing for each accelerator. Thus, the LM execution unit 802 can allow the FPGA 120 not to be used earlier than switching of the computer executing the VM 110 so that the FPGA 120 is not being used at the time of switching the computer executing the VM 110.

As in Example 1, the LM execution unit 802 determines whether the degree of progress taken to transmit data of the live migration of the VM 110 satisfies the second condition. As in Example 1, the LM execution unit 802 determines whether the FPGA 120 is executing the process on the VM 110. Then, as in Example 1, when the second condition is satisfied and the FPGA 120 is not executing the process on the VM 110, the LM execution unit 802 switches the computer executing the VM 110 to another computer.

Unlike Example 1, when the first condition that the degree of progress taken to transmit data is associated with one of the plurality of functions is satisfied, the FPGA access processing unit 803 causes the emulator 111 to execute the process using the function which satisfies the first condition.

For example, the FPGA access processing unit 803 causes the FPGA 120 to execute the process using the accelerator which does not satisfy the first condition whereas causing the emulator 111 to execute the process using the accelerator which satisfies the first condition. Specifically, the FPGA access processing unit 803 causes the emulator 111 to execute the process using the accelerator in which the emulator execution mode is set as the mode of the FPGA execution mode table 1900 illustrated in FIG. 19.

Thus, the FPGA access processing unit 803 can allow the FPGA 120 not to be used at the time of switching the computer executing the VM 110. Specifically, the FPGA access processing unit 803 can allow the FPGA 120 not to be used earlier than switching of the computer executing the VM 110.

For example, the FPGA access processing unit 803 causes the accelerator realized by the FPGA 120 to execute the process using the accelerator in which the hardware execution mode is set as the mode of the FPGA execution mode table 1900 illustrated in FIG. 19.

Thus, before the degree of progress taken to transmit data of the live migration of the VM 110 satisfies the first condition, the FPGA access processing unit 803 can cause the FPGA 120 to execute the process requested from the VM 110 to the FPGA 120 without change. Then, the FPGA access processing unit 803 can reduce the number of times the emulator 111 for which a time taken to execute a process is easily longer than the FPGA 120 is caused to execute the process requested from the VM 110 to the FPGA 120. As a result, the FPGA access processing unit 803 can suppress the deterioration in the performance of the VM 110.

As in Example 1, in a case in which the FPGA 120 is caused to execute the process, the FPGA access processing unit 803 sets “1” in the exec flag corresponding to the accelerator used for the process which the FPGA 120 is caused to execute in the FPGA execution status table 600 illustrated in FIG. 6. Thereafter, as in Example 1, in a case in which the FPGA 120 ends the process, the FPGA access processing unit 803 returns the exec flag corresponding to the accelerator used for the process ended by the FPGA 120 to “0” in the FPGA execution status table 600 illustrated in FIG. 6. Thus, the FPGA access processing unit 803 can determine whether the FPGA 120 is executing the process on the VM 110.

Module Configuration Example of Information Processing Apparatus 100 in Example 2

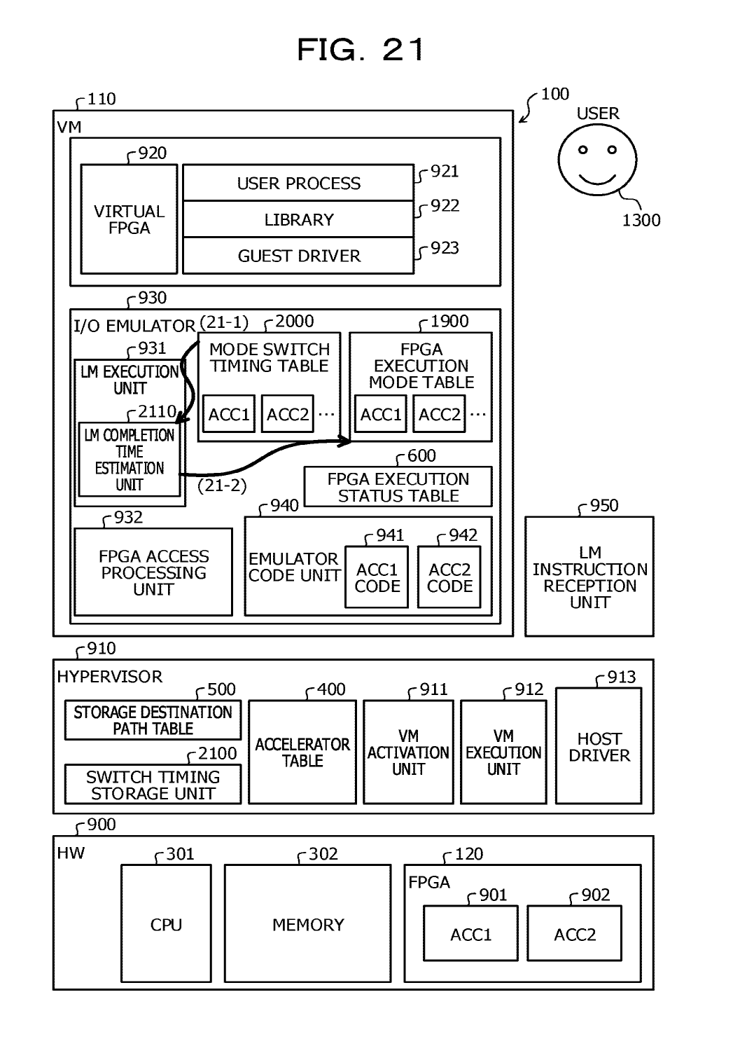

A module configuration example of the information processing apparatus 100 in Example 2 will be described with reference to FIG. 21.

FIG. 21 is an explanatory diagram illustrating a module configuration example of the information processing apparatus 100 according to Example 2. The description of the same portion as the module configuration example of the information processing apparatus 100 in illustrated in FIG. 9 in Example 1 in the module configuration example of the information processing apparatus 100 in Example 2 will be omitted.

In an example of FIG. 21, the hypervisor 910 further includes a switch timing storage unit 2100. The I/O emulator 930 further includes the FPGA execution mode table 1900 illustrated in FIG. 19 and the mode switch timing table 2000 illustrated in FIG. 20. The LM execution unit 931 further includes an LM completion time estimation unit 2110.

The switch timing storage unit 2100 can update the mode switch timing table 2000 illustrated in FIG. 20 and included in the I/O emulator 930 based on a manipulation input or the like from the user 1300. The LM completion time estimation unit 2110 can calculate a time remaining until the live migration is completed.

Example of Flow of Operation of Information Processing Apparatus 100 According to Example 2

Similarly, an example of the flow of an operation of the information processing apparatus 100 according to Example 2 will be described with reference to FIG. 21. Specifically, the flow of an operation of switching between the hardware execution mode and the emulator execution mode for each accelerator when the information processing apparatus 100 executes the live migration will be described. Here, the LM execution unit 931 is assumed to start transmitting the state of the VM 110 to the movement destination apparatus 130.

(21-1) The LM execution unit 931 reads a switch timing for each accelerator with reference to the mode switch timing table 2000 illustrated in FIG. 20. The LM execution unit 931 calculates a time remaining until the live migration is completed at a predetermined interval using the LM completion time estimation unit 2110 after start of transmission of the state of the VM 110 to the movement destination apparatus 130.

(21-2) The LM execution unit 931 compares the read switch timing for each accelerator to the calculated remaining time and determines whether there is the accelerator which satisfies the switch timing>the remaining time. The LM execution unit 931 determines whether there is the accelerator which satisfies the switch timing>the remaining time.

When there is the accelerator which satisfies the switch timing>the remaining time, the LM execution unit 931 switches the mode of the accelerator which satisfies the switch timing>the remaining time to the emulator execution mode in the FPGA execution mode table 1900 illustrated in FIG. 19. Thus, the LM execution unit 931 can allow the FPGA 120 not to be used earlier than switching of the computer executing the VM 110 so that the FPGA 120 is not being used at the time of switching the computer executing the VM 110.

Example of VM Activation Process Procedure in Example 2

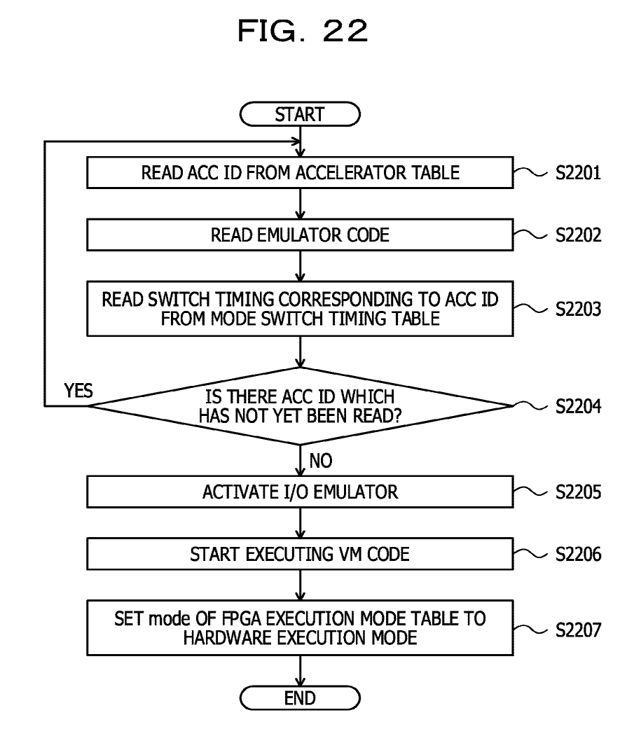

Next, an example of a VM activation process procedure in Example 2 will be described with reference to FIG. 22.

FIG. 22 is a flowchart illustrating an example of the VM activation process procedure according to Example 2. In FIG. 22, the VM activation unit 911 reads the ACC ID which has not yet been read from the accelerator table 400 (step S2201). Next, the VM activation unit 911 reads the bitfile path corresponding to the read ACC ID and reads the emulator code based on the read bitfile path (step S2202).

Then, the VM activation unit 911 reads the switch timing corresponding to the read ACC ID from the mode switch timing table 2000 (step S2203). Thereafter, the VM activation unit 911 determines whether there is the ACC ID which has not yet been read (step S2204). Here, in a case in which there is the ACC ID which has not yet been read (Yes in step S2204), the VM activation unit 911 returns the process to step S2201.

Conversely, in a case in which there is no ACC ID which has not yet been read (No in step S2204), the VM activation unit 911 embeds the read emulator code in the I/O emulator code and activates the I/O emulator 930 (step S2205). Here, the I/O emulator 930 causes the VM execution unit 912 to start executing the VM code (step S2206).

Then, the VM activation unit 911 sets the mode of the FPGA execution mode table 1900 to the hardware execution mode (step S2207). The VM activation unit 911 ends the VM activation process procedure. Thus, the VM activation unit 911 can activate the VM 110 in which the trouble rarely occurs in the movement destination apparatus 130 even when the emulator 111 corresponding to each accelerator is embedded and the live migration is executed.

Example of Hardware Access Process Procedure in Example 2

A hardware access process procedure in Example 2 is the same as the hardware access process procedure illustrated in FIG. 16 in Example 1, and thus the description thereof will be omitted.

Example of FPGA Access Process Procedure in Example 2

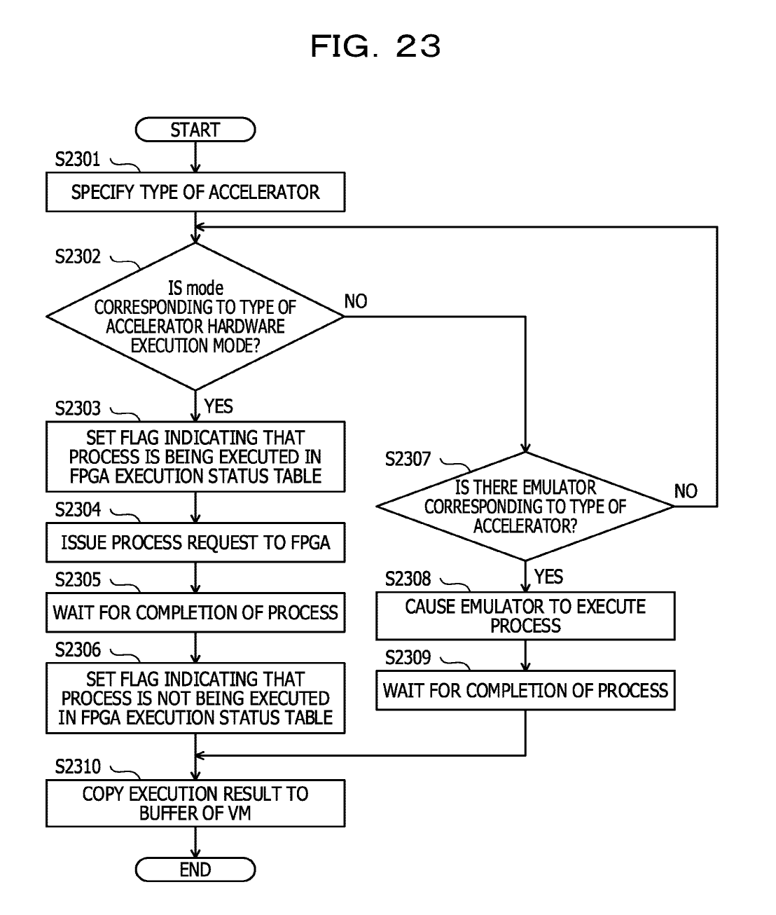

Next, an example of an FPGA access process procedure in Example 2 will be described with reference to FIG. 23.

FIG. 23 is a flowchart illustrating an example of the FPGA access process procedure according to Example 2. In FIG. 23, the FPGA access processing unit 932 specifies a type of accelerator used for the process from content of the process (step S2301). The FPGA access processing unit 932 determines whether the mode corresponding to the specified type of accelerator in the FPGA execution mode table 1900 is the hardware execution mode (step S2302). Here, in a case in which the mode is the hardware execution mode (Yes in step S2302), the FPGA access processing unit 932 transitions the process to step S2303.

In step S2303, the FPGA access processing unit 932 sets a flag indicating that the process is being executed in the exec flag corresponding to the accelerator used for the process in the FPGA execution status table 600 (step S2303). Next, the FPGA access processing unit 932 issues a process request for the process using the accelerator to the FPGA 120 (step S2304). Then, the FPGA access processing unit 932 waits for completion of the process (step S2305).

Thereafter, when the process is completed, the FPGA access processing unit 932 sets a flag indicating that the process is not being executed in the exec flag corresponding to the accelerator used for the process in the FPGA execution status table 600 (step S2306). Then, the FPGA access processing unit 932 transitions the process to step S2310.

Conversely, in a case in which the mode is not the hardware execution mode (No in step S2302), the FPGA access processing unit 932 subsequently determines whether there is the emulator code corresponding to the specified type of accelerator (step S2307). Here, in a case in which there is no emulator code (No in step S2307), the FPGA access processing unit 932 returns the process to step S2302.

Conversely, in a case in which there is the emulator code (Yes in step S2307), the FPGA access processing unit 932 causes the emulator 111 corresponding to the specified type of accelerator to execute the process (step S2308). Subsequently, the FPGA access processing unit 932 waits for completion of the process (step S2309). Thereafter, when the process is completed, the FPGA access processing unit 932 transitions the process to step S2310.

In step S2310, the FPGA access processing unit 932 copies an execution result of the process using the accelerator to a buffer of the VM 110 (step S2310). Then, the FPGA access processing unit 932 ends the FPGA access process. Thus, the information processing apparatus 100 can efficiently execute the process using the FPGA 120. The information processing apparatus 100 can operate the VM 110 in a status in which the trouble does not occur in the movement destination apparatus 130 even when the live migration is executed.

Example of LM Execution Process Procedure in Example 2

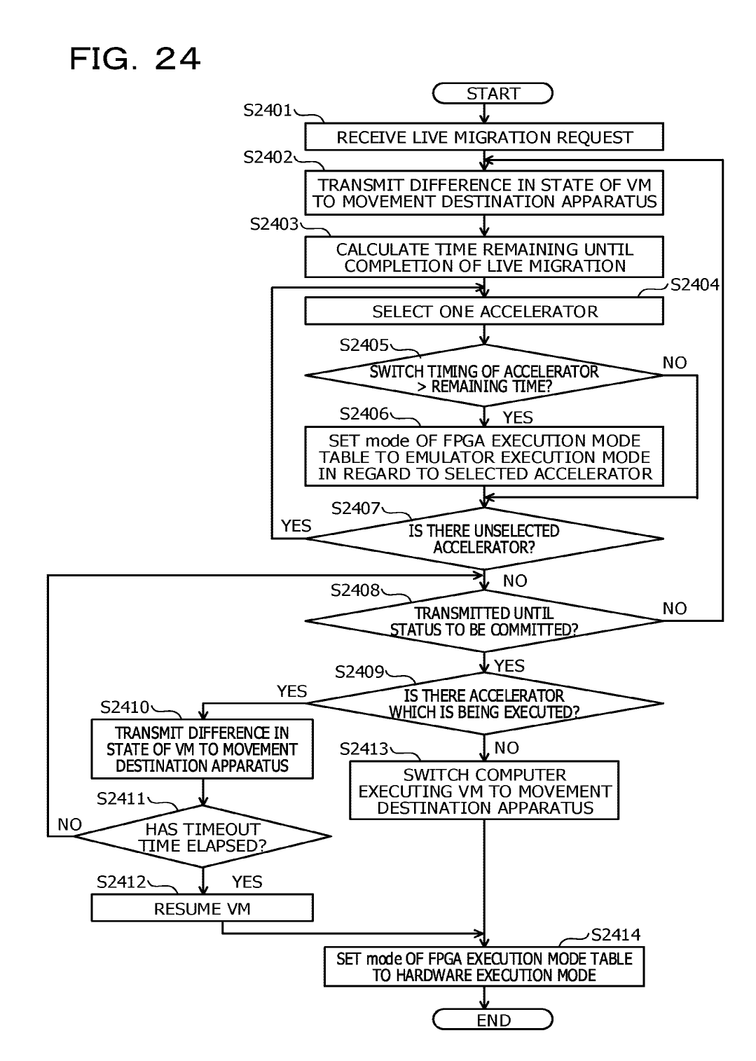

Next, an example of an LM execution process procedure in Example 2 will be described with reference to FIG. 24.

FIG. 24 is a flowchart illustrating an example of an LM execution process procedure according to Example 2. In FIG. 24, the LM execution unit 931 receives a live migration request (step S2401). Subsequently, the LM execution unit 931 transmits the difference in the state of the VM 110 to the movement destination apparatus 130 (step S2402). Then, the LM execution unit 931 calculates a time remaining until completion of the live migration (step S2403).

Subsequently, the LM execution unit 931 selects one accelerator (step S2404). Then, the LM execution unit 931 determines whether the switch timing of the selected accelerator>the calculated remaining time is satisfied (step S2405). Here, in a case in which the switch timing>the remaining time is not satisfied (No in step S2405), the LM execution unit 931 transitions the process to step S2407.

Conversely, in a case in which the switch timing>the remaining time (Yes in step S2405), the LM execution unit 931 sets the mode of the FPGA execution mode table 1900 to the emulator execution mode in regard to the selected accelerator (step S2406). Subsequently, the LM execution unit 931 determines whether there is an unselected accelerator (step S2407). Here, in a case in which there is the unselected accelerator (Yes in step S2407), the LM execution unit 931 returns the process to step S2404.

Conversely, when there is no unselected accelerator (No in step S2407), the LM execution unit 931 determines whether the difference in the state of the VM 110 is transmitted until a status to be committed (step S2408). The status to be committed is, for example, a status in which the computer executing the VM 110 may be switched. Here, in a case in which the difference in the state is not transmitted (No in step S2408), the LM execution unit 931 returns the process to step S2402.

Conversely, in a case in which the difference in the state is transmitted (Yes in step S2408), the LM execution unit 931 determines whether there is an accelerator which is being executed based on the FPGA execution status table 600 (step S2409). Here, in a case in which there is the accelerator which is being executed (Yes in step S2409), the LM execution unit 931 transmits the difference in the state of the VM 110 to the movement destination apparatus 130 (step S2410).

Next, the LM execution unit 931 determines whether a timeout time has elapsed from LM start (step S2411). Here, in a case in which the timeout time has not elapsed (No in step S2411), the LM execution unit 931 returns the process to step S2408.

Conversely, in a case in which the timeout time has elapsed (Yes in step S2411), the LM execution unit 931 notifies of a failure of the live migration, stops the live migration, and resumes the VM 110 (step S2412). Then, the LM execution unit 931 transitions the process to step S2414.

Conversely, in a case in which there is no accelerator which is being executed (No in step S2409), the LM execution unit 931 temporarily stops the VM 110 and switches the computer executing the VM 110 to the movement destination apparatus 130 (step S2413). Then, the LM execution unit 931 transitions the process to step S2414.

In step S2414, the LM execution unit 931 sets the mode of the FPGA execution mode table 1900 to the hardware execution mode (step S2414). Then, the LM execution unit 931 ends the LM execution process. Thus, the information processing apparatus 100 can execute the live migration so that occurrence of a trouble of the VM 110 in the movement destination apparatus 130 is suppressed.

Example 3 in Live Migration System 200

Next, Example 3 will be described. As described above, Example 3 is the same example as Example 2 and is an example in which a timing at which whether the FPGA 120 is caused to execute a process in Example 2 or the emulator 111 of the FPGA 120 is caused to execute a process is switched is dynamically changed.

Memory Content of Accelerator Table 400 in Example 3

Since memory content of the accelerator table 400 in Example 3 is the same as the memory content of the accelerator table 400 in Example 1 illustrated in FIG. 4, the description thereof will be omitted.

Memory Content of Storage Destination Path Table 500 in Example

Since memory content of the storage destination path table 500 in Example 3 is the same as the memory content of the storage destination path table 500 in Example 1 illustrated in FIG. 5, the description thereof will be omitted.

Memory Content of FPGA Execution Status Table 600 in Example 3

Since memory content of the FPGA execution status table 600 in Example 3 is the same as the memory content of the FPGA execution status table 600 in Example 1 illustrated in FIG. 6, the description thereof will be omitted.

Memory Content of FPGA Execution Mode Table 1900 in Example 3

Since memory content of the FPGA execution mode table 1900 in Example 3 is the same as the memory content of the FPGA execution mode table 1900 in Example 2 illustrated in FIG. 19, the description thereof will be omitted.

Memory Content of Mode Switch Timing Table 2000 in Example 3

Since memory content of the mode switch timing table 2000 in Example 3 is the same as the memory content of the mode switch timing table 2000 in Example 2 illustrated in FIG. 20, the description thereof will be omitted.

Functional Configuration Example of Information Processing Apparatus 100 in Example 3

Next, a functional configuration example of the information processing apparatus 100 in Example 3 will be described. A functional configuration example of the information processing apparatus 100 in Example 3 is the same as the functional configuration example of the information processing apparatus 100 illustrated in FIG. 8 in Example 1. In other words, the information processing apparatus 100 is configured to include a VM activation unit 801, an LM execution unit 802, and an FPGA access processing unit 803.

As in Example 1, the VM activation unit 801 embeds the emulator 111 which becomes a substitute of hardware capable of dynamically defining a function in the VM 110 at the time of activating the VM 110. Thus, the VM activation unit 801 can cause the I/O emulator 930 to start executing a VM code.

As in Example 1, the LM execution unit 802 starts the live migration of the VM 110 to another computer in response to reception of an instruction of the live migration of the VM 110 in which the emulator 111 is embedded.

As in Example 2, the LM execution unit 802 determines whether the degree of progress taken to transmit data of the live migration of the VM 110 satisfies the first condition corresponding to the accelerator for each accelerator realized by the VM 110. As in Example 2, the LM execution unit 802 causes the emulator 111 to execute the process using the accelerator that satisfies the first condition instead of the accelerator realized by the FPGA 120. Thus, the LM execution unit 802 can allow the FPGA 120 not to be used earlier than switching of the computer executing the VM 110 so that the FPGA 120 is not being used at the time of switching the computer executing the VM 110.

As in Example 1, the LM execution unit 802 determines whether the degree of progress taken to transmit data of the live migration of the VM 110 satisfies the second condition. As in Example 1, the LM execution unit 802 determines whether the FPGA 120 is executing the process on the VM 110. Then, as in Example 1, when the second condition is satisfied and the FPGA 120 is not executing the process on the VM 110, the LM execution unit 802 switches the computer executing the VM 110 to another computer.

As in Example 2, the FPGA access processing unit 803 causes the FPGA 120 to execute the process using the accelerator which does not satisfy the first condition whereas causing the emulator 111 to execute the process using the accelerator which satisfies the first condition. Thus, before the degree of progress taken to transmit data of the live migration of the VM 110 satisfies the first condition, the FPGA access processing unit 803 can cause the FPGA 120 to execute the process requested from the VM 110 to the FPGA 120 without change. As a result, the FPGA access processing unit 803 can suppress the deterioration in the performance of the VM 110.

As in Example 1, in a case in which the FPGA 120 is caused to execute the process, the FPGA access processing unit 803 sets “1” in the exec flag corresponding to the accelerator used for the process which the FPGA 120 is caused to execute in the FPGA execution status table 600 illustrated in FIG. 6. Thereafter, as in Example 1, in a case in which the FPGA 120 ends the process, the FPGA access processing unit 803 returns the exec flag corresponding to the accelerator used for the process ended by the FPGA 120 to “0” in the FPGA execution status table 600 illustrated in FIG. 6. Thus, the FPGA access processing unit 803 can determine whether the FPGA 120 is executing the process on the VM 110.

In addition to Example 2, the FPGA access processing unit 803 may measure a time taken to execute a process using each of the plurality of functions and update the association information based on the measured result. The function is, for example, an accelerator. The association information is, for example, the mode switch timing table 2000. In a case in which the FPGA 120 is caused to execute a process, for example, the FPGA access processing unit 803 measures a time taken to execute the process and updates a switch timing of the mode switch timing table 2000 illustrated in FIG. 20 based on the measured time.

Module Configuration Example of Information Processing Apparatus 100 in Example 3

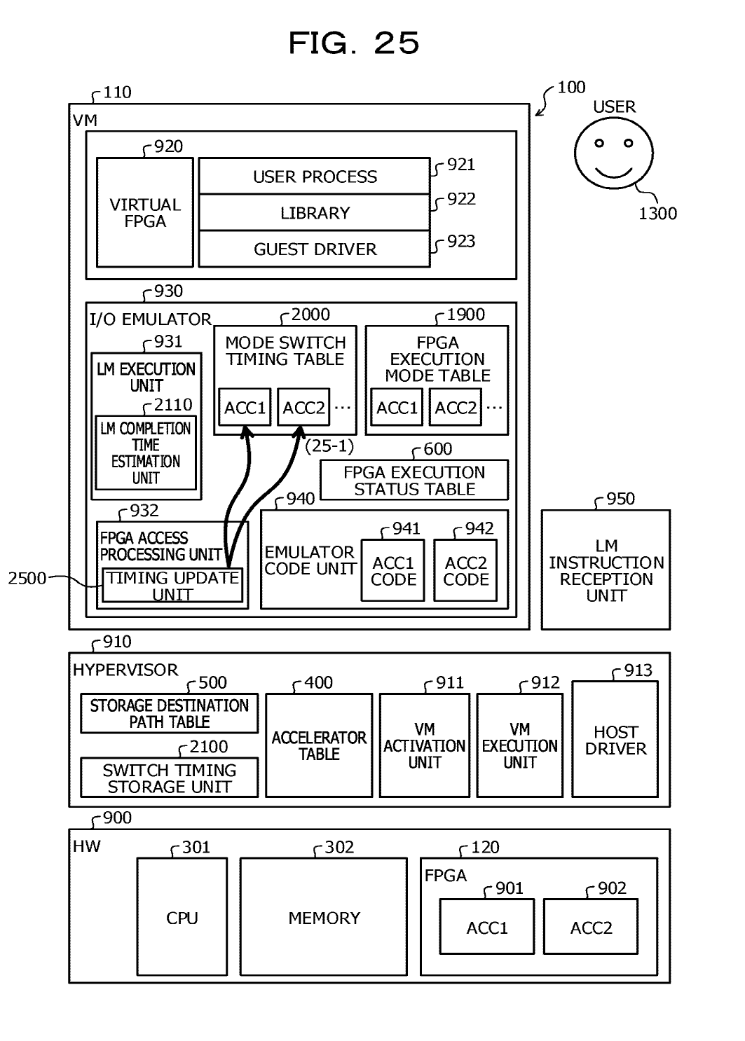

Next, a module configuration example of the information processing apparatus 100 according to Example 3 will be described with reference to FIG. 25.

FIG. 25 is an explanatory diagram illustrating a module configuration example of the information processing apparatus 100 according to Example 3. Description of the same portion as the module configuration example of the information processing apparatus 100 in illustrated in FIG. 21 in Example 2 in the module configuration example of the information processing apparatus 100 in Example 3 will be omitted.

In an example of FIG. 25, the FPGA access processing unit 932 further includes a timing update unit 2500. The timing update unit 2500 can measure a time taken to execute a process using the accelerator and update the mode switch timing table 2000 illustrated in FIG. 20 based on the measured result.

Example of Flow of Operation of Information Processing Apparatus 100 According to Example 3

Next, an example of the flow of an operation of the information processing apparatus 100 according to Example 3 will be described. Specifically, an example of the flow of an operation of updating the mode switch timing table 2000 illustrated in FIG. 20 based on a time taken to execute a process using the accelerator in the information processing apparatus 100 will be described.

(25-1) In a case in which the process using the accelerator realized by the FPGA 120 is executed, the timing update unit 2500 measures a time taken to execute the process using the accelerator. When the timing update unit 2500 measures the time taken to execute the process using the accelerator, the timing update unit 2500 updates the switch timing of the accelerator used for the process in the mode switch timing table 2000 illustrated in FIG. 20 based on the measured time.

Here, for example, when the measured time>the switch timing is satisfied, there is a possibility of the FPGA 120 being used at the time of switching the computer executing the VM 110. Therefore, for example, when the measured time>the switch timing is satisfied, the timing update unit 2500 overwrites the switch timing of the accelerator used for the process on the measured time in the mode switch timing table 2000 illustrated in FIG. 20.

Example of FPGA Access Process Procedure according to Example 3

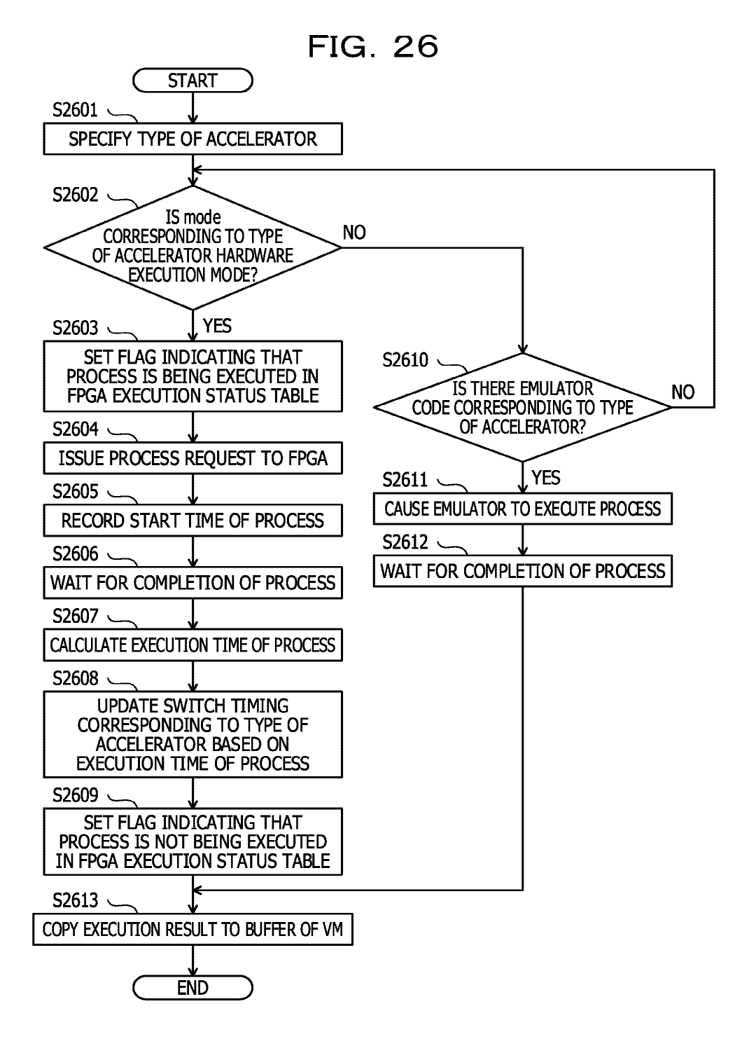

Next, an example of an FPGA access process procedure according to Example 3 will be described with reference to FIG. 26.

FIG. 26 is a flowchart illustrating an example of an FPGA access process procedure according to Example 3. In FIG. 26, the FPGA access processing unit 932 specifies a type of accelerator used for the process from content of the process (step S2601). The FPGA access processing unit 932 determines whether the mode corresponding to the specified type of accelerator in the FPGA execution mode table 1900 is the hardware execution mode (step S2602). Here, in a case in which the mode is the hardware execution mode (Yes in step S2602), the FPGA access processing unit 932 transitions the process to step S2603.

In step S2603, the FPGA access processing unit 932 sets a flag indicting that the process is being executed in the exec flag corresponding to the accelerator used for the process in the FPGA execution status table 600 (step S2603). Next, the FPGA access processing unit 932 issues a process request for the process using the accelerator to the FPGA 120 (step S2604). Here, the FPGA access processing unit 932 records a start time of the process (step S2605). Then, the FPGA access processing unit 932 waits for completion of the process (step S2606).

Thereafter, when the process is completed, the FPGA access processing unit 932 calculates an execution time of the process based on the recorded start time of the process (step S2607). Next, the FPGA access processing unit 932 updates the switch timing corresponding to the specified type of accelerator of the mode switch timing table 2000 based on the calculated execution time of the process (step S2608). Then, the FPGA access processing unit 932 sets a flag indicating that the process is not being executed in the exec flag corresponding to the accelerator used for the process in the FPGA execution status table 600 (step S2609) and transitions the process to step S2613.

Conversely, in a case in which the mode is not the hardware execution mode (No in step S2602), the FPGA access processing unit 932 subsequently determines whether there is the emulator code corresponding to the specified type of accelerator (step S2610). Here, in a case in which there is no emulator code (No in step S2610), the FPGA access processing unit 932 returns the process to step S2602.

Conversely, in a case in which there is the emulator code (Yes in step S2610), the FPGA access processing unit 932 causes the emulator 111 corresponding to the specified type of accelerator to execute the process (step S2611). Subsequently, the FPGA access processing unit 932 waits for completion of the process (step S2612). Thereafter, when the process is completed, the FPGA access processing unit 932 transitions the process to step S2613.

In step S2613, the FPGA access processing unit 932 copies an execution result of the process using the accelerator to a buffer of the VM 110 (step S2613). Thus, the information processing apparatus 100 can further reduce the possibility of the FPGA 120 being used at the time of switching the computer executing the VM 110 based on the time taken to execute the process actually using the accelerator.

As described above, the information processing apparatus 100 can start the live migration of the VM 110, in which the emulator 111 which becomes a substitute of the FPGA 120 is embedded, to the movement destination apparatus 130. The information processing apparatus 100 can cause the emulator 111 to execute the process requested from the VM 110 to the FPGA 120 when the degree of progress taken to transmit data satisfies the first condition. When the degree of progress taken to transmit data satisfies the second condition and the FPGA 120 is not executing the process on the VM 110, the information processing apparatus 100 can switch the computer executing the VM 110 to the movement destination apparatus 130. Thus, the information processing apparatus 100 can allow the FPGA 120 not to be used at the time of switching the computer executing the VM 110. Specifically, the information processing apparatus 100 can cause the FPGA 120 not to be used earlier than switching of the computer executing the VM 110. The information processing apparatus 100 can suppress occurrence of the trouble of the VM 110 in the movement destination apparatus 130.

When the degree of progress taken to transmit data does not satisfy the first condition, the information processing apparatus 100 causes the FPGA 120 to execute the process requested from the VM 110 to the FPGA 120. Thus, before the degree of progress taken to transmit data of the live migration of the VM 110 satisfies the first condition, the information processing apparatus 100 can cause the FPGA 120 to execute the process requested from the VM 110 to the FPGA 120 without change. Then, the information processing apparatus 100 can reduce the number of times the emulator 111 for which a time taken to execute a process is easily longer than the FPGA 120 is caused to execute the process requested from the VM 110 to the FPGA 120. As a result, the information processing apparatus 100 can suppress the deterioration in the performance of the VM 110.

The information processing apparatus 100 can use the condition that the live migration is being executed as the first condition. Thus, the information processing apparatus 100 can further reduce the possibility of the FPGA 120 being used at the time of switching the computer executing the VM 110. As a result, the information processing apparatus 100 can reduce a possibility of the completion of the live migration being delayed, and thus can suppress occurrence of the trouble of the VM 110 in the movement destination apparatus 130.

The information processing apparatus 100 can use the condition that the ratio of the information transmitted to the movement destination apparatus 130 to the information regarding the VM 110 is equal to or greater than the first threshold as the first condition. Thus, the information processing apparatus 100 can reduce the number of times the emulator 111 is caused to execute the process requested from the VM 110 to the FPGA 120 even when the live migration is being executed. As a result, the information processing apparatus 100 can suppress the deterioration in the performance of the VM 110.

The information processing apparatus 100 can use the condition that the time remaining until completion of the transmission of the information regarding the VM 110 to the movement destination apparatus 130 is equal to or less than the first threshold as the first condition. Thus, the information processing apparatus 100 can reduce the number of times the emulator 111 is caused to execute the process requested from the VM 110 to the FPGA 120 even when the live migration is being executed. As a result, the information processing apparatus 100 can suppress the deterioration in the performance of the VM 110.

The information processing apparatus 100 can refer to the association information in which the first condition is associated with each of the plurality of accelerators included in the FPGA 120. Then, when the degree of progress taken to transmit data satisfies the first condition associated with one of the plurality of accelerators, the information processing apparatus 100 can cause the emulator 111 to execute the process using the accelerator which satisfies the first condition. Thus, the information processing apparatus 100 can switch whether the FPGA 120 is caused to execute the process using the accelerator or the emulator 111 is caused to execute the process for each accelerator. The information processing apparatus 100 can reduce the number of times the emulator 111 is caused to execute the process requested from the VM 110 to the FPGA 120 even when the live migration is being executed. As a result, the information processing apparatus 100 can suppress the deterioration in the performance of the VM 110.

The information processing apparatus 100 can measure a time taken to execute the process using each of the plurality of accelerators and update the association information based on the measured result. Thus, the information processing apparatus 100 can further reduce the possibility of the FPGA 120 being used at the time of the switching the computer executing the VM 110 based on the time taken to execute the process actually using the accelerator.

The information processing apparatus 100 can use the condition that the ratio of the information transmitted to the movement destination apparatus 130 to the information regarding the VM 110 is equal to or greater than the second threshold as the second condition. Thus, the information processing apparatus 100 can determine a timing at which the live migration is completed.

The information processing apparatus 100 can use the condition that the time remaining until the completion of transmission of the information regarding the VM 110 to the movement destination apparatus 130 is equal to or less than the second threshold as the second condition. Thus, the information processing apparatus 100 can determine a timing at which the live migration is completed.

The information processing apparatus 100 can embed the emulator 111 in the VM 110 at the time of activating the VM 110. Thus, even when the emulator 111 is not embedded in advance in the VM 110, the information processing apparatus 100 can suppress the occurrence of the trouble of the VM 110 in the movement destination apparatus 130.

The information processing apparatus 100 can use, as the emulator 111, software that outputs dummy data corresponding to any of one or more accelerators realized by the FPGA 120. Thus, even in a case in which there is no emulator 111 capable of executing the same operation as the operation of the accelerator, the information processing apparatus 100 suppress the occurrence of the trouble of the VM 110 in the movement destination apparatus 130 when the live migration of the VM 110 is executed.

The information processing apparatus 100 can use, as the emulator 111, software that waits for a predetermined time until dummy data is output. Thus, the information processing apparatus 100 can suppress a case in which the VM 110 receiving the dummy data causes the emulator 111 to execute the process again and a process is congested in the emulator 111.

The information processing apparatus 100 can use, as the emulator 111, software that outputs the same error response to an error response output when any of one or more accelerators realized by the FPGA 120 fails to execute a process. Thus, even in a case in which there is no emulator 111 capable of executing the same operation as the operation of the accelerator, the information processing apparatus 100 suppress the occurrence of the trouble of the VM 110 in the movement destination apparatus 130 when the live migration of the VM 110 is executed.

The information processing apparatus 100 can use, as the emulator 111, software that waits for a predetermined time until an error response is output. Thus, the information processing apparatus 100 can suppress a case in which the VM 110 receiving the error response causes the emulator 111 to execute the process again and a process is congested in the emulator 111.

The information processing apparatus 100 can use, as the emulator 111, software that waits without executing a process. Thus, the information processing apparatus 100 can cause the VM 110 to execute a process again after a predetermined time elapses and can normally execute a process when the live migration is completed at the time of executing the process again. Even in a case in which there is no emulator 111 capable of executing the same operation as the operation of the accelerator, the information processing apparatus 100 suppress the occurrence of the trouble of the VM 110 in the movement destination apparatus 130 when the live migration of the VM 110 is executed.

The live migration method described in the embodiment can be realized when a program prepared in advance is executed by a computer such as a personal computer or a workstation. The live migration program is recorded on a computer-readable storage medium such as a hard disk, a flexible disk, a CD-ROM, an MO, or a DVD and is executed when a computer reads the live migration program from the recording medium. The live migration program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium that stores a live migration program that causes a computer to execute a process, the process comprising:
starting live migration of a virtual machine to another computer in response to reception of an instruction of the live migration of the virtual machine, an emulator which becomes a substitute for hardware capable of dynamically defining a function is implemented in the virtual machine;
causing the emulator to execute a requested process requested from the virtual machine to the hardware when a degree of progress taken to transmit data of the live migration of the virtual machine satisfies a first condition; and
switching the computer executing the virtual machine to the other computer when the degree of progress satisfies a second condition to determine whether the computer executing the virtual machine is switched and when the hardware is not executing a process of the virtual machine.

2. The non-transitory computer-readable storage medium according to claim 1, wherein the process comprises:
causing the hardware to execute the requested process requested from the virtual machine to the hardware when the degree of progress does not satisfy the first condition.

3. The non-transitory computer-readable storage medium according to claim 1, wherein
the first condition indicates that the live migration is being executed.

4. The non-transitory computer-readable storage medium according to claim 1, wherein
the first condition indicates that a ratio of information has been transmitted to the other computer in whole of information, regarding the virtual machine, need to be transmitted is equal to or greater than a first threshold.

5. The non-transitory computer-readable storage medium according to claim 1, wherein
the first condition indicates that a time remaining until completion of transmission of information, regarding the virtual machine, need to be transmitted to the other computer is equal to or less than a first threshold.

6. The non-transitory computer-readable storage medium according to claim 1, wherein the process comprises:
specifying a function corresponding to the requested process among from a plurality of functions of the hardware;
obtaining a specified first condition corresponding to the specified function, from a plurality of first conditions, based on association information, the association information being information that associates each of the plurality of functions with the plurality of first conditions, the plurality of first conditions being different in accordance with a function to which each of the plurality of first conditions; and
determining whether the emulator executes the requested process or not based on the specified first condition.

7. The non-transitory computer-readable storage medium according to claim 6, wherein the process comprises:
measuring a time taken to execute the requested process using each of the plurality of functions; and
updating the association information based on a measurement result of the measuring.

8. The non-transitory computer-readable storage medium according to claim 1, wherein
the second condition indicates that a ratio of a data amount has been transmitted to the other computer in whole of a data amount of the data, regarding the virtual machine, need to be transmitted is equal to or greater than a second threshold.

9. The non-transitory computer-readable storage medium according to claim 1, wherein
the second condition indicates that a time remaining until completion of transmission of the data, regarding the virtual machine, need to be transmitted is equal to or less than a third threshold.

10. The non-transitory computer-readable storage medium according to claim 1, wherein the process comprises:
implementing the emulator in the virtual machine at the time of activating the virtual machine.

11. A live migration method executed by a computer, the live migration method comprising:
starting live migration of a virtual machine to another computer in response to reception of an instruction of the live migration of the virtual machine, an emulator which becomes a substitute for hardware capable of dynamically defining a function is implemented in the virtual machine;
causing the emulator to execute a requested process requested from the virtual machine to the hardware when a degree of progress taken to transmit data of the live migration of the virtual machine satisfies a first condition; and
switching the computer executing the virtual machine to the other computer when the degree of progress satisfies a second condition to determine whether the computer executing the virtual machine is switched and when the hardware is not executing a process of the virtual machine.

12. A live migration apparatus comprising:
a memory; and
a processor coupled to the memory and the processor configured to:
start live migration of a virtual machine to another computer in response to reception of an instruction of the live migration of the virtual machine, an emulator which becomes a substitute for hardware capable of dynamically defining a function is implemented in the virtual machine;
cause the emulator to execute a requested process requested from the virtual machine to the hardware when a degree of progress taken to transmit data of the live migration of the virtual machine satisfies a first condition; and
switch the computer executing the virtual machine to the other computer when the degree of progress satisfies a second condition to determine whether the computer executing the virtual machine is switched and when the hardware is not executing a process of the virtual machine.
